(19) United States
(12) Patent Application Publication
(10) Pub. No.: US 2026/0070071 A1
(43) Pub. Date: Mar. 12, 2026

(54) QUAD-MODE FAUCET

(71) Applicant: Nebia Inc., San Francisco, CA (US)

(72) Inventors: Brian Gabriel Willkom, Santa Clara, CA (US); David Amadeus Zacher, Albany, CA (US); Max Peralta Nyffeler, San Francisco, CA (US); Eric Allen Wooley, San Francisco, CA (US)

(21) Appl. No.: 19/323,223

(22) Filed: Sep. 9, 2025

Related U.S. Application Data
(60) Provisional application No. 63/692,518, filed on Sep. 9, 2024.

(51) Int. Cl. B05B 1/16; B05B 1/18

(52) U.S. Cl. CPC B05B 1/1609; B05B 1/169; B05B 1/18

(57) ABSTRACT

One variation of a system includes: a housing including a fluid inlet coupled to a fluid supply; a set of nozzles arranged on a distal end of the housing and including an aerator nozzle, a soft-flow nozzle, and a flat-fan nozzle; a momentary shutoff button arranged on the housing and configured to transition a momentary shutoff valve between positions to selectively pass fluid from the fluid supply to the set of nozzles; a primary flow selector valve configured to selectively pass fluid from the fluid supply to the set of nozzles; a secondary flow selector valve configured to selectively pass fluid from the primary flow selector valve to the set of nozzles; and a flow selector button arranged on the housing and configured to transition the primary flow selector valve and the secondary flow selector valve to selectively pass fluid to the set of nozzles.

### CROSS-REFERENCE TO RELATED APPLICATIONS

This application claims the benefit of U.S. Provisional Application No. 63/692,518, filed on 9 Sep. 2024, which is incorporated in its entirety by this reference.

This application is related to U.S. patent application Ser. No. 18/077,959, filed on 8 Dec. 2022, which is a continuation of U.S. patent application Ser. No. 16/566,777, filed on 10 Sep. 2019, now U.S. Pat. No. 11,548,015, which claims the benefit of U.S. Provisional Application No. 62/729,349, filed on 10 Sep. 2018, and is a continuation-in-part application of U.S. patent application Ser. No. 16/541,069, filed on 14 Aug. 2019, each of which is incorporated in its entirety by this reference. U.S. patent application Ser. No. 16/541,069, filed on 14 Aug. 2019, is a continuation of U.S. patent application Ser. No. 15/895,913, filed on 13 Feb. 2018, now U.S. Pat. No. 10,421,083, which is a continuation of Ser. No. 15/273,684, filed on 22 Sep. 2016, now U.S. Pat. No. 9,931,651, which is a continuation-in-part application of U.S. patent application Ser. No. 14/814,721, filed on 31 Jul. 2015, now U.S. Pat. No. 9,925,545, which claims the benefit of U.S. Provisional Application No. 62/043,095, filed on 28 Aug. 2014, each of which is incorporated in its entirety by this reference.

### TECHNICAL FIELD

This invention relates generally to the field of plumbing and, more specifically, to a new and useful faucet for consistent experiences over a range of flow rates in the field of plumbing.

### BRIEF DESCRIPTION OF THE FIGURES

FIGS. 1A and 1B are schematic representations of a system;

FIG. 2 is a schematic representation of a showerhead;

FIG. 3 is a schematic representation of a faucet;

FIG. 4 is a schematic representation of one variation of the showerhead;

FIG. 5 is a schematic representation of one variation of the showerhead;

FIG. 6 is a graphical representation of one variation of the showerhead;

FIG. 7 is a graphical representation of one variation of the system;

FIG. 8 is a graphical representation of one variation of the system;

FIG. 9A is a schematic representation of one variation of the faucet;

FIG. 9B is a schematic representation of one variation of the faucet;

FIG. 9C is a schematic representation of one variation of the faucet;

FIG. 10A is a schematic representation of one variation of the faucet;

FIG. 10B is a schematic representation of one variation of the faucet; and

FIG. 10C is a schematic representation of one variation of the faucet.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

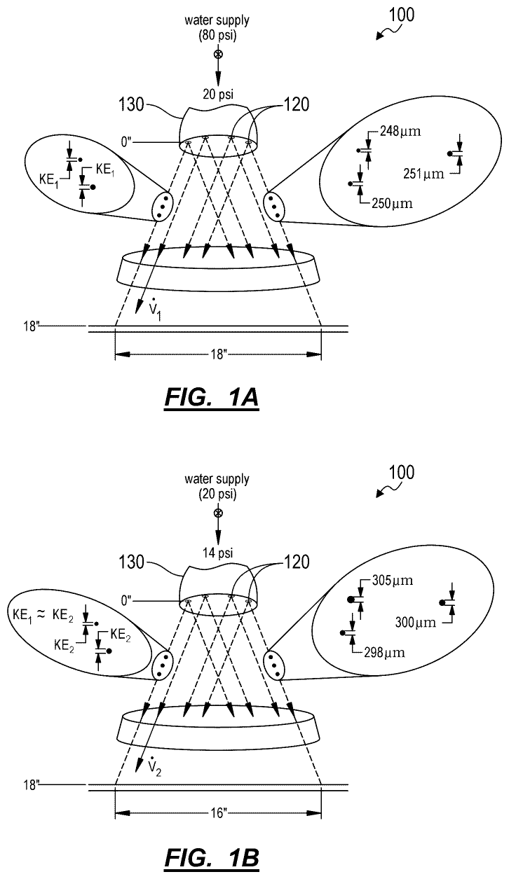

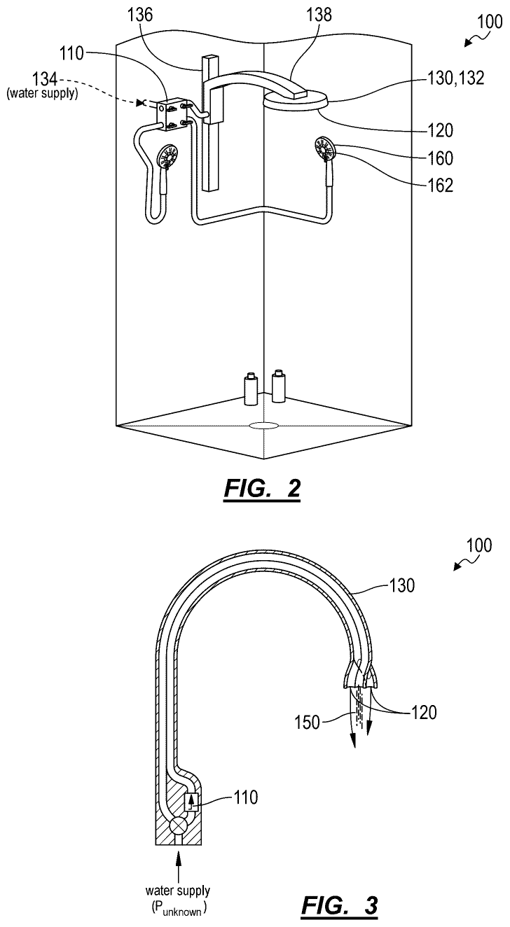

As shown in FIGS. 1A and 1B and FIG. 2, a system 100 includes: a mount 136 including a proximal end defining a fluid inlet 134 configured to couple to a fluid supply; a body 130 defining a fluid circuit 132 and coupled to the mount 136; and a pressure regulator 110 interposed between the fluid inlet 134 and the fluid circuit 132 and configured to regulate a fluid supply at the fluid inlet 134 over a range of inlet pressures to a range of internal pressures in the fluid circuit 132, the range of internal pressures less than and narrower than the range of inlet pressures. In response to the pressure regulator 110 regulating water supplied at a first inlet pressure at the fluid inlet 134 down to a first internal pressure in the fluid circuit 132. The system 100 also includes a set of nozzles 120 arranged on the body 130 and coupled to the fluid circuit 132, the set of nozzles 120 configured to discharge water droplets that exit the body 130 with kinetic energies in a first range of kinetic energies and that form a first spray pattern that extends from the body 130, defines a first width at a target distance below the body 130, and exhibits a first volumetric ratio of water to air. In response to the pressure regulator 110 regulating water supplied at a second inlet pressure less than the first inlet pressure at the fluid inlet 134 down to a second internal pressure less than the first internal pressure in the fluid circuit 132, the set of nozzles 120 is further configured to discharge water droplets exiting the body 130 with kinetic energies in a second range of kinetic energies approximating the first range of kinetic energies and forming a second spray pattern that extends from the body 130 approximating the first spray pattern, defines a second width approximating the first width at the target distance below the body 130, and exhibits a second volumetric ratio of water to air approximating the first volumetric ratio.

In one variation, the system 100 includes: a mount 136 including a proximal end defining a fluid inlet 134 configured to couple to a fluid supply; a body 130 defining a fluid circuit 132; a set of nozzles 120 arranged on the body 130 and coupled to the fluid circuit 132; and a pressure regulator 110 interposed between the fluid inlet 134 and the fluid circuit 132. The pressure regulator 110 is configured to regulate a fluid supply at the fluid inlet 134 over a range of inlet pressures to a range of internal pressures less than and narrower than the range of inlet pressures. In response to supply of water at a first inlet pressure in the range of inlet pressures at the fluid inlet 134: the pressure regulator 110 regulates the supply of water down to a first internal pressure, in the range of internal pressure; and the set of nozzles 120 discharges water droplets a) exiting the body 130 at a first exit velocity, b) exhibiting a first size range, and c) in a first spray pattern extending from the body 130, defining a first width at a target distance below the body 130, and exhibiting a first volumetric ratio of water to air. In response to supply of water at a second inlet pressure in the range of inlet pressures and less than the first inlet pressure at the fluid inlet 134: the pressure regulator 110 regulates the supply of water down to a first internal pressure, in the range of internal pressures; and the set of nozzles 120 discharges water droplets a) exiting the body 130 at a second exit velocity less than the first exit velocity, b) exhibiting a second size range greater than the first size range, and c) in a second spray pattern extending from the body 130 approximating the first spray pattern, defining a second width approximating the first width at the target distance below the body 130, and exhibiting a second volumetric ratio of water to air approximating the first volumetric ratio.

### 1.1 Applications

Generally, the system 100 includes a pressure regulator 110 and a set of nozzles 120 that cooperate to discharge water droplets in a target spray pattern-within a bathing environment-exhibiting narrow, controlled ranges of droplet inertia (or “energy”), droplet heat loss, volumetric flux (i.e., volume flow across a unit area), and spray geometry over a range of distances from the set of nozzles 120 despite a wide range of possible fluid supply pressures at the bathing environment. In particular, the system 100 includes a set of nozzles 120—fluidly coupled to an upstream pressure regulator 110—that output a cloud of water droplets in a target spray pattern that balances rinsing efficacy (e.g., as a function of droplet kinetic energy and volumetric flux), warmth (e.g., user perception of droplet temperature near her torso as a function of droplet heat loss and volumetric flux), and droplet sensation (e.g., delicate rather than stinging as a function of droplet inertia) in order to achieve a consistent shower experience for a user substantially regardless of water pressure supplied to the system 100.

The pressure regulator 110 can regulate a fluid supply—which may fall within a wide range of 20 pounds per square inch (hereinafter “psi”) to 80 psi in more than 95% of showers in the United States of America-down to a narrow range of internal pressures (e.g., between 14 psi and 20 psi). The set of nozzles 120 can define orifice geometries and can be arranged in a pattern within a showerhead that yields substantially consistent droplet kinetic energy, droplet heat loss, volumetric flux, and spray geometry over a range of distances from the set of nozzles 120 substantially regardless of fluid supply pressure (e.g., within a range of fluid supply pressures between 20 psi and 80 psi). Therefore, the pressure regulator 110 and the set of nozzles 120 can cooperate to yield a consistent experience (such as given consistent inlet temperatures) in a variety of bathing environments, such as: in showers in both the first floor and top floor of a high-rise building (i.e., high and low fluid supply pressures, respectively); in new construction with new plumbing and in old construction with clogged pipes; in buildings with and without water pressure boosters; and in buildings with well-supplied water and in buildings with water supplied by a municipality or water department; etc.

The set of nozzles 120 cooperate with the pressure regulator 110 to discharge water droplets sufficiently small (e.g., less than 500 micrometers in width) such that water droplets exhibit a greater hang time than larger water droplets generated by typical showerheads in order to yield a relatively high volumetric ratio of water droplets to air within a cloud of water droplets while operating at lower flow rates than typical showerheads.

In one implementation, the pressure regulator 110 and the set of nozzles 120 are incorporated into a showerhead to regulate a fluid supply of unknown or variable pressure (hereinafter “inlet pressure”) to within a narrow range of lower internal pressures in order to achieve a consistent shower experience for a user. In particular, the pressure regulator 110 and the set of nozzles 120 cooperate to discharge water droplets within a narrow range of sizes and speeds and in a target spray pattern to form a droplet cloud that: achieves a relatively long hang time (i.e., a time that these droplets remain in the air before reaching the bottom of a shower pan); achieves a degree of heat retention sufficient to provide a sense of warmth at a user's torso; achieves kinetic energies that avoid “stinging” sensations upon impact with a user's skin; and achieves a high volumetric ratio of water droplets to air within a greater discharged cloud or “curtain” of droplets around a user. Such characteristics of the cloud of water droplets discharged by the set of nozzles 120 may translate into a “pleasant” shower experience for a user, including yielding perceptions of “warmth,” “softness,” “fullness” (e.g., a high volumetric ratio of water to air near the user's torso), and “wetness” while enabling efficient rinsing during a shower and despite a wide range of possible inlet pressures and inlet pressure variance.

### 1.2 Example

In one implementation, the system 100 includes: a mount 136 defining a proximal end configured to couple to a fluid supply; a body 130 of maximum width less than eight inches, defining a fluid circuit 132, and coupled to the mount 136 to form a showerhead; a pressure regulator 110 interposed between the fluid inlet 134 and the fluid circuit 132 and configured to regulate a fluid supply at the fluid inlet 134 over a range of inlet pressures approximately (e.g., within 10%) between 20 psi and 80 psi down to a lesser and narrower range of internal pressures approximately between 14 psi and 20 psi; and a set of six full cone nozzles 120 arranged on the body 130 in a circular pattern of radius less than four inches and coupled to the fluid circuit 132. The set of six full cone nozzles 120 cooperate with the pressure regulator 110 to discharge water droplets: predominantly between 130 micrometers and 430 micrometers in width (e.g., more than 90% of droplets exhibiting widths in this range); at flow rates between 0.8 gallons-per-minute and 1.5 gallons-per-minute; and in a first spray pattern extending from the body 130, defining a first width of at least 12 inches at a target distance below the body 130, and exhibiting a high volumetric ratio of water to air (e.g., greater than 5%, that is significantly greater than 100% relative humidity generated by a showerhead with jets or aerator). In particular, because the volumetric ratio of water to air dispensed by the set of nozzles 120 is high in the vicinity of the user's head and torso, the user may perceive this cloud of droplets as “full,” “immersive,” and/or “enveloping.”

For example, in this implementation, the pressure regulator 110 can regulate a fluid supply at the fluid inlet 134 at a first inlet pressure of 80 psi down to a first internal pressure of 20 psi. The set of nozzles 120 can then cooperate with the pressure regulator 110 to discharge water droplets: exhibiting an average width of 250 micrometers; at a flow rate of 1.35 gallons-per-minute; in a first conical spray pattern at a first spray angle proportional to the first internal pressure; and that form a first droplet cloud of approximately a target width (e.g., 18 inches) at a distance of 18 inches from the body 130.

In this example, the pressure regulator 110 can similarly regulate a fluid supply at a second inlet pressure of 20 psi at the fluid inlet 134 down to a second internal pressure of 14 psi. The set of nozzles 120 can then cooperate with the pressure regulator 110 to discharge water droplets: exhibiting an average width of 300 micrometers; at a flow rate of approximately 1.05 gallons-per-minute; in a second conical spray pattern at a second spray angle proportional to the second internal pressure; and that form a second droplet cloud of approximately the target width at a distance of 18 inches from the body 130. In these examples, for a fluid inlet 134 pressure of 80 psi, the set of nozzles 120 can discharge droplets that form a droplet cloud approximately 18 inches wide (i.e., less than 20 inches wide) at a distance of 18 inches from the body 130; and for a fluid inlet 134 pressure of 20 psi, the set of nozzles 120 can discharge droplets that form a droplet cloud approximately 17 inches wide (i.e., more than 16 inches wide) at a distance of 18 inches from the body 130.

### 1.3 Shower Experience

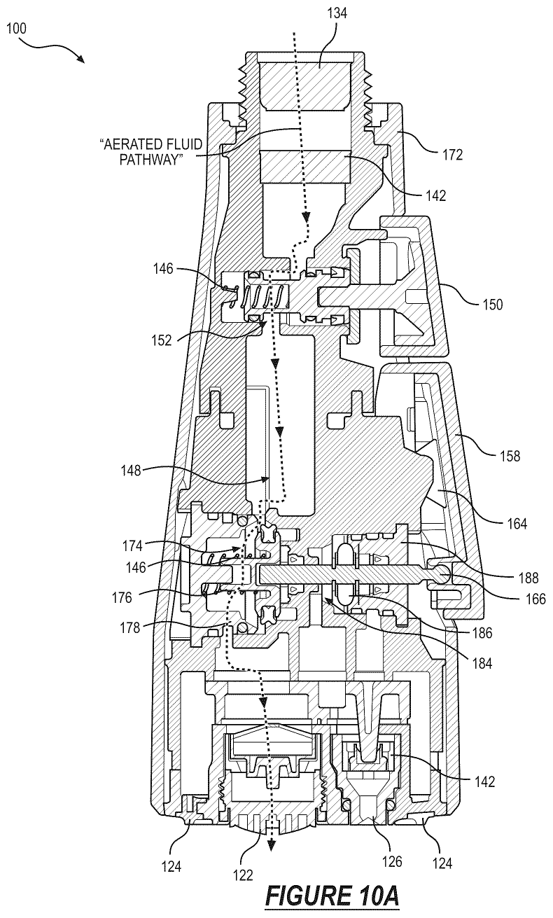

The system 100 can discharge droplets within a narrow range of exit velocities and exhibiting sizes within a narrow range of droplet sizes to achieve: a target rinsing efficacy; a user perception of warmth; target body coverage; and a gentle sensation of droplets, as shown in FIG. 8.

For example, for a higher inlet pressure (e.g., 80 psi), the pressure regulator 110 outputs an internal pressure at an upper bound of the narrow range of internal pressures; accordingly, the set of nozzles 120 discharge smaller droplets at a higher flow rate and at higher exit velocities. These droplets form a droplet cloud of width near an upper bound of a target width range (e.g., 18″ wide at 18″ below the head) such that a user bathing under the system 100 perceives that she is fully bathed in water. Because these droplets are relatively small, these droplets may individually exhibit lower heat retention. However, this cloud of smaller droplets may also exhibit longer hang time than a cloud of larger droplets and may thus achieve greater heat retention en masse, thereby producing a sensation of warmth for the user.

Additionally, in response to the pressure regulator 110 regulating a higher inlet pressure down to an internal pressure at an upper bound of the narrow range of internal pressures, the showerhead discharges relatively smaller droplets at relatively higher flowrates, which may counteract the lower heat retention of the smaller droplets and thus maintain a sensation of warmth for the user.

Conversely, for a lower inlet pressure (e.g., 20 psi), the pressure regulator 110 outputs an internal pressure at a lower bound of the narrow range of internal pressures. Accordingly, the set of nozzles 120 discharges larger water droplets at a lower flow rate and at lower exit velocities. These droplets may form a droplet cloud of approximately the target width such that the user bathing under the system 100 again perceives that she is fully bathed in water and experiences a sensation of “wetness”. These droplets form a droplet cloud of width near a lower bound of the target width range (e.g., 16″ wide at 18″ below the head) such that a user bathing under the system 100 similarly perceives that she is fully bathed in water. Though flow rate through the system may be lower at lower inlet pressures, these droplets discharged by the system 100 are relatively large and may thus exhibit greater heat retention, thereby producing a sensation of warmth for the user.

Furthermore, in the foregoing example, in response to the pressure regulator 110 regulating a high inlet pressure (e.g., 80 psi) down to a high internal pressure (e.g., 20 psi), the set of nozzles 120 can discharge water droplets exiting the body 130 at approximately a first exit velocity (e.g., within 5% of) and approximately exhibiting (e.g., within 10% of) a first size. In response to the pressure regulator 110 regulating a second inlet pressure less than the first inlet pressure down to a second internal pressure less than the first inlet pressure, the set of nozzles 120 can discharge water droplets exiting at approximately a second exit velocity less than the first exit velocity and approximately exhibiting a second size greater than the first size. Therefore, the total kinetic energies of droplet clouds output by the set of nozzles 120 at the upper and lower bounds of the range inlet pressures may be similar and less than a droplet kinetic energy typically associated with transition of human dermal sensation from gentle impact of water droplets to stinging impact of water droplets.

The combination of the lower flow rate, larger droplets, and slower droplets discharged by the system 100 at the low inlet pressure may thus yield a similar—and sufficient—rinsing efficacy as the higher flow rate, smaller droplets, and faster droplets discharged by the system 100 at the high inlet pressure. Therefore, the pressure regulator 110 and the set of nozzles 120 can cooperate to achieve similar rinsing efficacies across this wide range of possible inlet pressures.

Thus, the system 100 can fluidly couple to a fluid supply of unknown or variable pressure (or “inlet pressure”) and regulate this fluid supply at unknown inlet pressure down to an internal pressure within a target internal pressure range and then discharge water droplets in a droplet cloud that approximates a target spray pattern, kinetic energy, heat retention, and flow rate that consistently yields a target shower experience for a user despite unknown or variable pressure of the fluid supply. The system 100 can thus yield sufficient rinsing efficacy, sufficient perception of warmth for a user (e.g., minimum temperature of droplets upon impact with a human body), sufficient body coverage (e.g., minimum width of a droplet cloud at distances from the showerhead), and sufficient droplet sensation (e.g., gentle droplet impact on skin of a user) for a user at relatively low flow rate and despite unknown or variable pressure of the fluid supply.

### 1.4 Shower Experience Control

Generally, by regulating water supplied at an unknown inlet pressure down to a narrow range of internal pressures and by discharging water regulated down to this narrow range of internal pressures through a set of nozzles 120, the system 100 can isolate droplet sensation (e.g., droplet softness versus droplet “stinginess”) from other droplet characteristics (e.g., flow rate, spray pattern, temperature). More specifically, with the narrow range of internal pressures, the set of nozzles 120 may discharge droplets in similar spray patterns, at similar flow rates, and with similar temperature loss over a distance (e.g., 20 inches) from the body 130. However, droplet size may increase and droplet exit velocity may decrease with lower internal pressures—and therefore lower inlet pressures—and vice versa. Therefore, a user may manipulate a set of external shower controls to vary inlet pressure at the fluid inlet 134—such as from a lower bound of 20 psi to a maximum water pressure in the user's shower stall—in order to predominantly modify the sensation of droplets discharged from the system 100 while minimally effecting other rinsing efficacy, flow rate, spray pattern, and/or other droplet characteristics.

For example, a user may open shower controls to start a shower. Once the shower controls are opened by a minimum threshold to yield a fluid inlet 134 pressure of 20 psi at the fluid inlet 134, these shower controls may be substantially decoupled from water flow rate, rinsing efficacy, and spray pattern output by the system 100. At this minimum threshold, the system 100 discharges largest water droplets of slowest velocity. As the user further opens the shower control, the fluid inlet 134 pressure at the fluid inlet 134 may increase, and the system 100 discharges smaller water droplets of greater velocity. In one example, if the nozzles discharge droplets of size and velocity that vary linearly and inversely as a function of internal pressure, the average kinetic energy of droplets discharged by the system 100 as the user opens the shower controls may increase, thereby increasing a possibility that the user experiences a “stinging” sensation from these discharged droplets. Accordingly, the user may adjust the shower controls to achieve her preferences for “softness” and “stinginess” of her shower. Therefore, the system 100 enables a user a user to finely adjust the sensation of droplets by adjusting the supply pressure of water with the shower controls, and the system 100 transforms the external shower control from a flow controller that varies volume flow rate into a droplet sensation control that varies droplet kinetic energy while maintaining substantially constant volume flow rate through the system.

### 2. Variation

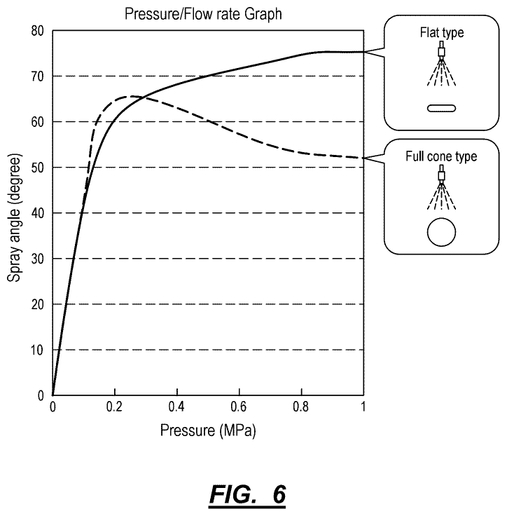

As shown in FIG. 4, one variation of the system 100 includes: a pressure regulator 110 configured to regulate a fluid supply of unknown and variable pressure down to a target pressure; a manifold 140 fluidly coupled to an outlet of the pressure regulator 110; a set of nozzles 120 fluidly coupled to the manifold 140 and configured to discharge water droplets; and a set of flow restrictors 142 interposed between the pressure regulator 110 and select nozzles in the set of nozzles 120 to match sizes, speeds, and distributions of water droplets discharged from the set of nozzles 120 to a target shower experience based on an outlet pressure of the pressure regulator 110.

### 2.1 Variation: Faucet

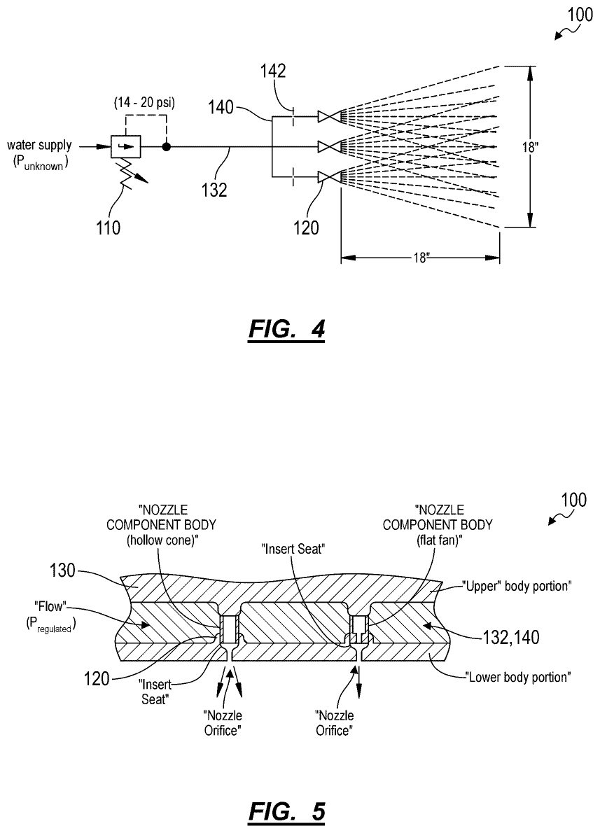

As shown in FIGS. 3, 9A-9C, and 10A-10C, one variation of the system 100 includes: a housing 172 including a fluid inlet fluidly coupled to a fluid supply; a cavity 148 fluidly coupled to and downstream of the fluid inlet; and a momentary shutoff valve 152 fluidly coupled to and interposed between the fluid inlet and the cavity 148. The momentary shutoff valve 152 is configured to: pass fluid from the fluid inlet into the cavity 148 in an open mode; and block passage of fluid from the fluid inlet into the cavity 148 in a closed mode.

The system 100 also includes: a first spring 146 configured to bias the momentary shutoff valve 152 in the open mode; a momentary button 150 arranged on the housing 172 and configured to transition the momentary shutoff valve 152 between the open mode and the closed mode; an aerator nozzle 122 arranged on a distal end of the housing 172; a soft-flow nozzle 124 arranged on the distal end of the housing 172 adjacent the aerator nozzle 122; and a flat-fan nozzle 126 arranged on the distal end of the housing 172 adjacent the soft-flow nozzle 124 and the aerator nozzle 122.

The system 100 further includes a primary flow selector valve 174: fluidly coupled to and downstream of the cavity 148; and including a primary valve seat 178 and a primary piston 176. The primary piston 176 is unseated from the primary valve seat 178 in an aerated mode to: pass fluid from the cavity 148 to the aerator nozzle 122; and block passage of fluid from the cavity 148 to a secondary flow selector valve 184. Additionally, the primary piston 176 is seated on the primary valve seat 178 in an intermediate mode to: pass fluid from the cavity 148 to the secondary flow selector valve 184; and block passage of fluid from the cavity 148 to the aerator nozzle 122.

The system 100 also includes: a second spring 146 configured to bias the primary piston 176 in the aerated mode; and the secondary flow selector valve 184 fluidly coupled to and downstream of the primary flow selector valve 174 and including a secondary valve seat 188 and a secondary piston 186. The secondary piston 186 is unseated from the secondary valve seat 188 in a soft-flow mode to: pass fluid from the primary flow selector valve 174, in the intermediate mode, to the soft-flow nozzle 124; and block passage of fluid from the primary flow selector valve 174, in the intermediate mode, to the flat-fan nozzle 126. Additionally, the secondary piston 186 is seated on the secondary valve seat 188 in a flat-fan mode to: pass fluid from the primary flow selector valve 174, in the intermediate mode, to the flat-fan nozzle 126; and block passage of fluid from the primary flow selector valve 174, in the intermediate mode, to the soft-flow nozzle 124.

The system 100 further includes: a third spring 146 configured to bias the secondary flow selector valve 184 in the soft-flow mode; and a shaft 166 coupled to the secondary piston 186. The shaft 166 is operable in: a first position locating the secondary piston 186 in the flat-fan mode; and a second position locating the secondary piston 186 in the soft-flow mode. The shaft 166 includes a distal end configured to drive the primary piston 176 from the aerated mode into the intermediate mode during transition of the shaft 166 from the first position into the second position.

The system 100 also includes a flow selector button 158: arranged on the housing 172; coupled to the shaft 166; and configured to transition the shaft 166 between the first position and the second position.

### 2.2 Variation: Faucet with Removable Spray Head

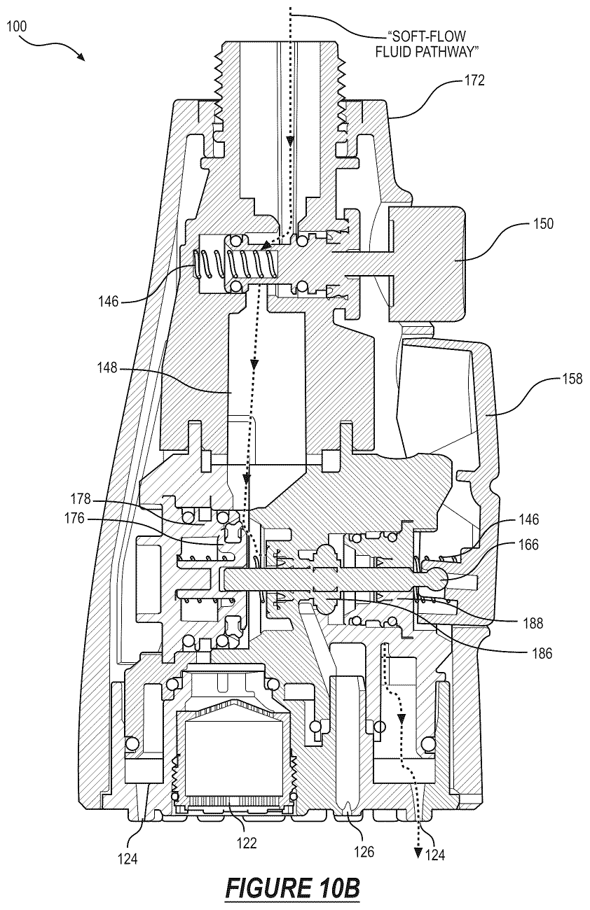

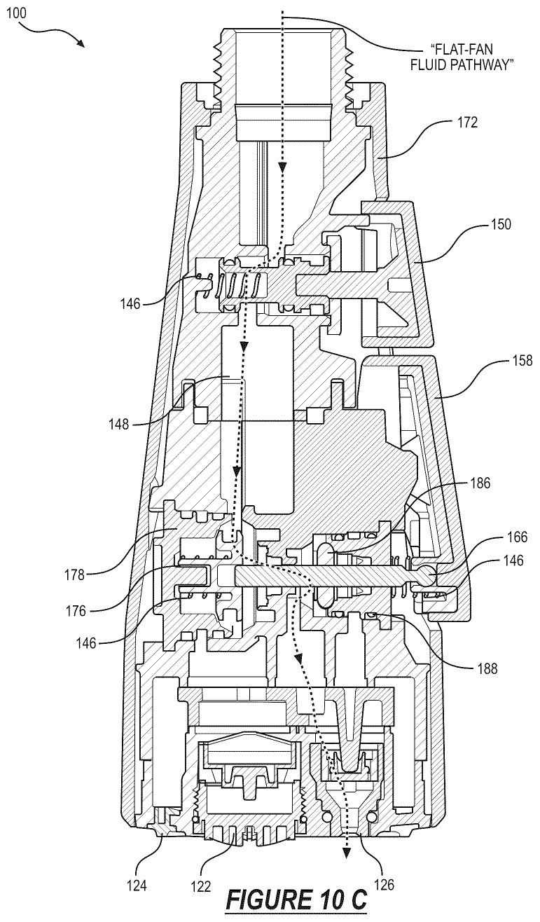

As shown in FIGS. 9A-9C and 10A-10C, one variation of the system 100 includes a removable spray head 170 and a set of flow restrictors (e.g., orifice plates), arranged within the removable spray head 170 and corresponding to a set of nozzles 120. For example, the faucet 100 can include a set of three flow restrictors 142, each flow restrictor 142 cooperating with a particular nozzle (e.g., flat-fan, plain orifice, and/or unregulated fluid) to discharge droplets of different target sizes and/or at different target speeds to form sprays of different geometries. Therefore, the faucet 100 can include the set of flow restrictors to adjust the flow rate for each particular spray pattern, such as when filling a pot, rinsing a dish, and washing her hands.

### 2.3 Applications

Generally, in this variation, the showerhead includes a combination of an upstream pressure regulator 110, downstream nozzles, and flow restrictors 142 arranged between the pressure regulator 110 and nozzles, all of which cooperate to discharge water droplets within a narrow range of target sizes (e.g., diameters) and within a narrow range of target speeds within a greater curtain or droplet cloud of a particular target geometry matched to a particular bathing, washing, or rinsing experience (e.g., a particular feeling of “wetness” and warmth) while limiting water consumption. The pressure regulator 110, downstream nozzles, and flow restrictors 142 are described herein as incorporated into a showerhead and cooperate to regulate a fluid supply of unknown pressure and variance over time down to target inlet pressures at nozzles. Accordingly, the set of nozzles 120 discharge water droplets of sizes and speeds that extend hang time, achieve a degree of heat retention sufficient to provide a sense of warmth before passing a user's torso, achieve kinetic energies that avoid “stinging” sensations upon impact with a user's skin, and achieve a high volumetric ratio of water droplets to air within a greater discharged cloud or “curtain” of droplets around a user, all of which may translate into sensations of “warmth,” “softness,” and “wetness” while maintain enabling efficient rinsing during a shower. In this example, by further focusing the curtain or droplet cloud to a limited volume that encompasses a portion of a human user's body (e.g., the user's head and torso up to a width of 14″ for a user standing under the showerhead), the pressure regulator 110, downstream nozzles 120, and flow restrictors 142 can cooperate to minimize water consumption without substantively impacting the user's showering experience.

Generally, a typical showerhead with jets or an aerator configured to output large drops of water (e.g., greater than one millimeter in diameter) or continuous streams of water may yield an experience (e.g., senses of warmth and wetness) that improves with greater supply pressure and greater volume flow rate (while diminishing a sensation of softness) and therefore greater water consumption. However, a showerhead including a set of nozzles 120 configured to output smaller droplets of water (e.g., 130 microns to 430 microns) may discharge a curtain or droplet cloud exhibiting peak sensations of warmth and of wetness-without substantially reducing a sensation of softness—at a lower regulated pressure and lower flow rate (e.g., 1.0 gallon per minute rather than, for example, 2.5 gallons per minute for a jetted showerhead). Unlike a jetted showerhead, increased inlet pressure and flow rate may reduce droplet size, increase droplet speed, and increase spray angles of the set of nozzles 120, all of which may reduce a sensation of warmth and reduce a sensation of softness while increasing water consumption and without substantively increasing a sensation of wetness (e.g., since large spray angles resulting from the increased flow rate may increase the size of the curtain or droplet cloud discharged by the set of nozzles 120 but not substantively increase the volumetric ratio of droplets to air within the shower).

Therefore, the showerhead can include a pressure regulator 110 that cooperates with downstream flow restrictors 142 to achieve target inlet pressures across the set of nozzles 120, which thus yields target droplet sizes, target droplet speeds, and a target geometry of a greater curtain or droplet cloud discharged from this set of nozzles 120 despite the pressure (e.g., temperature and variations thereof) of a fluid supply. In particular, the pressure regulator 110, downstream flow restrictors 142, and nozzles can be matched to achieve a consistent, quality shower experience (e.g., high perception of warmth, softness, rinsability, and wetness) for a user showering under the showerhead while limiting water consumption and airborne moisture outside of the curtain or droplet cloud despite a fluid supply of unknown and possible varying pressure (and temperature, etc.).

However, the pressure regulator 110, downstream flow restrictors 142, and nozzles can be integrated into a faucet 100, a bathroom faucet, or other fluid dispenser to similarly achieve better, more controlled experiences for a user and with less water consumption.

### 3. Pressure Block+Nozzles

The pressure regulator 110 is configured to regulate a fluid supply-such as a tap into a water main-down to a maximum pressure matched to downstream nozzle types, nozzle arrangement, and flow restrictor arrangement within the showerhead. In particular, the pressure regulator 110 can be coupled to a fluid supply of unknown—and possibly varying—pressure (e.g., between 25 psi and 80 psi) and can output water a pressure that is the lesser of: the pressure of the fluid supply; and a target water pressure matched to the nozzle and flow restrictor configuration of the showerhead to achieve a particular shower experience for a user.

Generally, a typical showerhead with jets or an aerator regulates water flow via a flow rate regulator, specifically monitoring flowrates. Alternatively, the pressure regulator 110 is configured to regulate water pressure, monitoring inlet pressures and regulating a fluid inlet 134 pressure down to an internal pressure.

The pressure regulator 110 can be: interposed between a fluid inlet 134 configured to couple to a fluid supply and a fluid circuit 132; and configured to regulate a fluid supply at the fluid inlet 134 over a range of inlet pressures to a range of internal pressures in the fluid circuit 132, the range of internal pressures less than and narrower than the range of inlet pressures.

In one variation, the pressure regulator 110 can be configured to regulate a fluid supply at the fluid inlet 134 over a range of inlet pressures between 20 psi and 80 psi to a range of internal pressures predominantly between 14 psi and 20 psi (i.e., with 90% of internal pressures in this range) in the fluid circuit 132. For example, the pressure regulator 110 can be configured to: regulate water supplied at a first inlet pressure of 80 psi down to a first internal pressure of 20 psi in the fluid circuit 132; and regulate water supplied at a second inlet pressure of 20 psi down to a second internal pressure of 14 psi in the fluid circuit 132. Therefore, the pressure regulator 110 can regulate water supplied at a wide range of inlet pressures down to a narrower and lower range of internal pressures to cooperate with a set of nozzles 120 downstream and thus achieve a particular shower experience for a user.

The set of nozzles 120 can be arranged on a body 130 defining the fluid circuit 132 and can be configured to: in response to the pressure regulator 110 regulating water supplied at a first inlet pressure at the fluid inlet 134 down to a first internal pressure in the fluid circuit 132, discharge water droplets exiting the body 130 with kinetic energies in a first range of kinetic energies (e.g., between 0.118 microjoules and 2.40 microjoules), and in a first spray pattern extending from the body 130, defining a first width at a target distance below the body 130, and exhibiting a first volumetric ratio of water to air; and, in response to the pressure regulator 110 regulating water supplied at a second inlet pressure less than the first inlet pressure at the fluid inlet 134 down to a second internal pressure less than the first internal pressure in the fluid circuit 132, discharge water droplets exiting the body 130 with kinetic energies in a second range of kinetic energies approximating the first range of kinetic energies, and in a second spray pattern extending from the body 130 approximating the first spray pattern, defining a second width approximating the first width at the target distance below the body 130, and exhibiting a second volumetric ratio of water to air approximating the first volumetric ratio.

### 3.1 Maximum Droplet Size

In particular, the pressure regulator 110 can be configured to regulate a fluid supply down to a pressure matched to configurations of nozzles within the showerhead such that these nozzles discharge droplets within a target narrow range of sizes. Generally, a ratio of the rate of heat transfer and heat capacity of a volume of liquid may be inversely correlated to a size of the volume. More specifically, a smaller droplet may be characterized by a larger ratio of surface area to volume, which may yield faster equilibration of the droplet's temperature and an ambient temperature and therefore sensation of a “colder” droplet for a user.

Generally, a nozzle exposed to a higher pressure at its nozzle inlet may discharge smaller droplets, which may therefore retain less mass-averaged thermal energy at greater distances from the nozzle and thus yield a colder shower (or washing) experience for a user. For example, jets common in showerheads or aerators in faucets may discharge large drops of water or continuous streams (or “jets”) of water that exhibit relatively low ratios of surface area to volume and therefore retain more mass-averaged thermal energy between the jet or aerator and a terminal destination (e.g., a floor of a shower, a sink); such jets and aerators may also exhibit low sensitivity to pressure variations, and a user's bathing or washing experience may improve (e.g., greater senses of wetness and warmth) as pressure at the jet or aerator inlet increases and as flow rate through the jet or aerator increases. However, the showerhead includes nozzles that may exhibit relatively high sensitivity to inlet pressure, wherein the average size of droplets discharged by the nozzle varies as a function of inlet pressure (e.g., inversely correlated to inlet pressure above a low inlet pressure). Therefore, the pressure regulator 110 can regulate the fluid supply to a target pressure that yields lower inlet pressures at the set of nozzles 120, thereby increasing sizes of droplets discharged by these nozzles, yielding an increased temperature of these droplets at greater distances from the showerhead, and increasing a sensation of “warmth” for a user showering under this showerhead.

In one variation, the pressure regulator 110 and the set of nozzles 120 cooperate to discharge water droplets predominantly (e.g., greater than 90%) between 130 micrometers and 430 micrometers in width. (Alternatively, the pressure regulator 110 and the set of nozzles 120 cooperate to discharge water droplets with average widths between 130 micrometers and 430 micrometers in width.) For example, in response to the pressure regulator 110 regulating a first inlet pressure of 80 psi down to a first internal pressure of 20 psi at the fluid circuit 132, the set of nozzles 120 can discharge droplets of a first width of 250 micrometers and with a first thermal energy. In response to the pressure regulator 110 regulating a second inlet pressure of 20 psi down to second internal pressure of 14 psi at the fluid circuit 132, the set of nozzles 120 can discharge droplets of a second width of 300 micrometers and with a second thermal energy greater than the first thermal energy. Therefore, the pressure regulator 110 and the set of nozzles 120 can cooperate to discharge droplets within a narrow range of internal pressures to achieve a target droplet size within a range of sizes proportional to the thermal energy of the droplets.

### 3.2 Maximum Droplet Exit Speed

Similarly, the showerhead includes nozzles that may discharge droplets at velocities that vary proportional to the pressure at their nozzle inlets. Generally, greater nozzle inlet pressure may yield droplets that reach a terminal destination (e.g., the floor of the shower, a sink) in less time and therefore yield a lower volumetric ratio of water droplets to air between the nozzle outlet and the terminal destination at any instant in time. Conversely, a lower droplet velocity may yield increased “hang time” between ejection of the droplet from the nozzle outlet and arrival of the droplet at the terminal destination, such as due to air currents within the shower carrying or “upwelling” smaller droplets, as described below. In particular, greater hang time over many droplets ejected from the set of nozzles 120 in the showerhead over time may: yield a greater volumetric ratio of water to air between these nozzles and the terminal destination; wet an object (e.g., a user's body) in less time; yield a greater sensation of “wetness” for a human bathing or washing within the space between the set of nozzles 120 and the terminal destination; and displace cooler air out of this space with more heated droplets of water; and thus achieve greater heat retention and a sensation of higher temperature within this space.

Therefore, the pressure regulator 110 can regulate the fluid supply down to the target pressure that yields slower droplet exit speeds at the outlet of the nozzle.

### 3.3 Minimum Droplet Size

Conversely, smaller droplets may be carried upwardly (i.e., against the flow of droplets out of a nozzle and toward a terminal destination below) over greater distances, at greater frequencies, and/or over greater periods of time by air currents within the shower, such as occurring due to thermal gradients from the floor below the showerhead to the ceiling above the showerhead and/or due to a shower fan arranged in the ceiling. Thus, smaller droplets may exhibit greater hang time between ejection of the droplet from the nozzle outlet and arrival of the droplet at the terminal destination. Greater average droplet hang time may increase the average volumetric ratio of water droplets to air within a cloud or curtain of droplets—discharged by the showerhead—at any instant in time, which may yield a greater sensation of “wetness” for a user. However, small droplets exhibiting greater hang times may also move behind the curtain or droplet cloud at greater distances and/or greater frequency, thereby increasing humidity beyond the curtain or droplet cloud in the space occupied by the user under the showerhead, thereby reducing humidity control outside of the shower, increasing heat transfer from the user's skin to water vapor in the air outside of the shower when the user later exits the shower, and thus increasing the user's sensation of “cold” and discomfort when the user later exits the shower.

In one example, at an upper bound of droplet size, droplets discharged by nozzles in the showerhead may be too large for air currents within the shower (e.g., from a temperature gradient in the shower and from a shower fan drawing air upward) to impart an upward force on these droplets—moving downward from the showerhead—of sufficient magnitude to slow these droplets and thus substantively increase hang time for these larger droplets. Therefore, the pressure regulator 110 can regulate the fluid supply down to the lesser of a supply pressure and the target pressure that yields droplets small enough to be “upwelled” by air currents within the shower, thereby achieving greater hang times for these small droplets and thus achieving a droplet curtain or droplet cloud containing a higher volumetric ratio of water to air at any instant in time despite a lower total volume flow rate through the showerhead than a showerhead containing standard jets or an aerator.

More specifically, the pressure regulator 110 can regulate a fluid supply to a target pressure such that the set of nozzles 120 discharge droplets: of sizes large enough to exhibit a minimum heat retention; small enough and slow enough to be lifted by air currents within the shower; but not so small and/or so slow as to be carried well beyond a target geometry of the curtain or droplet cloud thus discharged by the showerhead.

### 3.4 Combined Droplet Exit Speed and Droplet Size

Similarly, increasingly smaller sizes and increasing speeds of droplets discharged from the set of nozzles 120 may, at some bound, yield a “stinging” sensation for a human bathing or washing under the nozzle. Therefore, the pressure regulator 110 can regulate the fluid supply down to a target pressure (or narrow pressure range) that yields nozzle inlet pressures that produce both larger droplet sizes and slower droplet exit speeds at the outlet of the nozzle and thus increase comfort for a user bathing or washing under the nozzle.

For example, the set of nozzles 120 can be configured to: discharge water droplets exiting the body 130 at a first exit velocity and exhibiting a first average size in response to the pressure regulator 110 regulating water supplied at a first inlet pressure at the fluid inlet 134 down to a first internal pressure in the fluid circuit 132; and discharge water droplets exiting the body 130 at a second exit velocity less than the first exit velocity and exhibiting a second average size greater than the first average size in response to the pressure regulator 110 regulating water supplied at a second inlet pressure less than the first inlet pressure at the fluid inlet 134 down to a second internal pressure less than the first internal pressure in the fluid circuit 132.

Similarly, the set of nozzles 120 is configured to: discharge water droplets exiting the body 130 with kinetic energies in a first range of kinetic energies in response to the pressure regulator 110 regulating water supplied at the first inlet pressure at the fluid inlet 134 down to the first internal pressure in the fluid circuit 132; and discharge water droplets exiting the body 130 with kinetic energies in a second range of kinetic energies approximating the first range of kinetic energies in response to the pressure regulator 110 regulating water supplied at the second inlet pressure less than the first inlet pressure at the fluid inlet 134 down to the second internal pressure less than the first internal pressure in the fluid circuit 132.

Therefore, the set of nozzles 120 and the pressure regulator 110 cooperate to discharge droplets that exhibit (average) kinetic energies within a narrow or target range of kinetic energies outside of kinetic energies that commonly yield “stinging” sensations for humans.

### 3.5 Nozzle Discharge Geometry

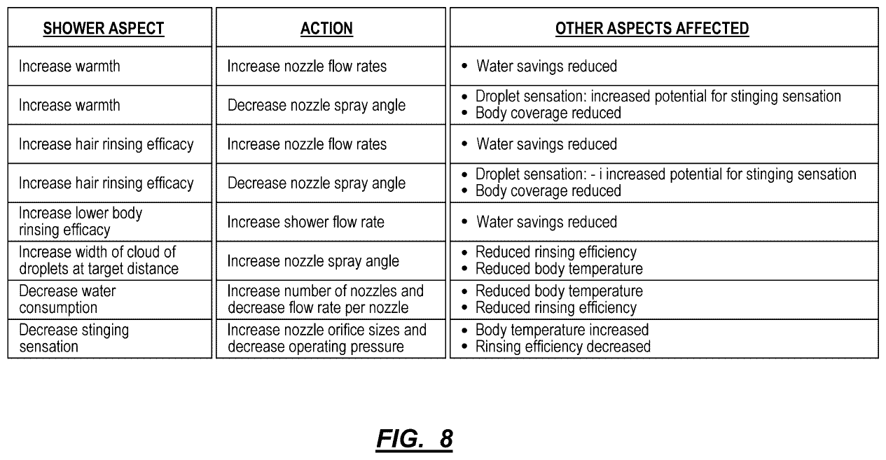

Furthermore, the showerhead can include flat-fan, hollow cone, and/or full cone nozzles that output droplets at spray angles that change as a function of (e.g., directly proportional to) nozzle inlet pressure, as shown in FIG. 6. Therefore, the pressure regulator 110 can regulate the fluid supply down to the target pressure that is: sufficiently low to yield larger water droplets and slower droplet exit speeds, as described above; and sufficiently high to yield fans and cones of droplets-discharged from these nozzles—that exhibit spray angles that fall within a narrow target spray angle range.

Generally, the showerhead can be configured to discharge droplets of fluid downward toward a user's head and shoulders while the user bathes under the showerhead. In one implementation, the showerhead includes a set of nozzles 120 that cooperate to discharge droplets in the form of a curtain of a geometry that substantially encompasses the user's head and shoulders. Humans-including adults and children-exhibit head sizes and shoulder widths that fall within relatively narrow ranges (e.g., 6″+/−2″ for widths of human heads, 16″+/−4″ for widths of human shoulder). In order to discharge droplets in a curtain that envelops a user's head and most or all of the user's shoulders with nozzles arranged in a showerhead of a limited size (e.g., less than 10″ in diameter), the showerhead can include a set of flat-fan nozzles 126 arranged in a circular pattern adjacent and tangent to the perimeter of the showerhead and angled relative to a primary axis of the showerhead such that flat-fans of droplets discharged from these nozzles meet to form a curtain approximately 14″ in diameter at a distance of 20″ from the showerhead. In this implementation, the pressure regulator 110 can consistently regulate water supplied to these nozzles down to a target pressure such that these flat-fan nozzles 126 discharge water droplets at target spray angles to achieve this curtain geometry. In a similar implementation: the showerhead can include an array of full cone and/or hollow cone nozzles; and the pressure regulator 110 can consistently regulate water supplied to these nozzles down to a target pressure such that these flat-fan nozzles discharge water droplets at target spray angles that together yield a droplet cloud approximately 20″ wide and 14″ deep at a distance of 20″ from the showerhead.

Therefore, in these implementations, the pressure regulator 110 can regulate a fluid supply—which may be supplied at a wide, inconsistent, and varying range of pressures, such as from 25 psi to 80 psi, and vary by as much as 50% responsive to other water use in the same structure-down to a consistent target pressure that yields droplet discharges at consistent target spray angles from nozzles in the showerhead. By thus achieving consistent droplet discharge from these nozzles, these droplets may form a droplet curtain or droplet cloud of a consistent geometry matched to a common or average shape and size of humans, thereby achieving a consistent experience for a user during one shower with the showerhead, across multiple showers with the showerhead, and across multiple different units of the showerhead despite changes in fluid supply pressure at a showerhead over time or differences in fluid supply across various showerhead installations. Furthermore, by thus regulating the supply pressure down to the target pressure to yield droplets of a particular size and exit speed within a curtain or cloud of a particular geometry, the showerhead can also both a) achieve a pleasant bathing experience for a user who is thus enveloped in this curtain or cloud and b) minimize water waste, since the showerhead discharges little or no water droplets outside of this curtain or cloud and since droplets inside this curtain either contact the user before reaching their terminal destination or shield other droplets closer to the user from cooler air outside of the curtain or cloud, thereby maintaining an elevated temperature inside the curtain or cloud.

(In one variation in which the pressure regulator 110, the set of nozzles 120, and the flow restrictors 142 are integrated into a faucet 100 configured to discharge droplets of fluid downward toward a soiled dish while a user cleans or rinses the dish in a sink, the faucet 100 can include a set of nozzles 120 that cooperate to discharge droplets in the form of a fan or curtain: spanning a portion of the width of the dish (e.g., a 6″-wide fan at a distance of 8″ from a head of the faucet 100); and containing droplets of a particular size, speed, and density sufficient to break food particles from the surface of the dish. Therefore, in order to achieve this target fan or curtain geometry with droplet sizes, speeds, and densities that enable rapid removal of food from a dish with reduced water consumption (i.e., “fast” and “efficient” rinsing) in a faucet 100 containing nozzles characterized by relatively low flow rate and relatively small droplet size—despite unknown water pressures and water pressure variations in a building in which the faucet 100 is installed—the faucet 100 can include the pressure regulator 110 configured to output water at a target pressure matched to geometries of the set of nozzles 120 integrated into the faucet 100.)

### 3.6 Nozzle Arrangement

In one implementation, the set of nozzles 120 includes nozzles arranged in a circular pattern about the body 130. For example, the body 130 can define an eight-inch-diameter cylindrical section, and the set of nozzles 120 can include six nozzles arranged in a circular pattern—of radius less than four inches—centered about one side of the body 130. In this example, the set of nozzles 120 can discharge water droplets in conical sprays extending outwardly from the body 130 and at conical angles proportional to internal pressure. In particular, the set of nozzles 120 can: discharge a droplet cloud exhibiting minimum width greater than sixteen inches at a distance of eighteen inches below the body 130 in response to the pressure regulator 110 regulating an a first inlet pressure of 80 psi down to first internal pressure of 20 psi; and discharge a droplet cloud exhibiting maximum width less than twenty inches at the distance of eighteen inches below the body 130 in response to the pressure regulator 110 regulating a second inlet pressure of 20 psi down to a second internal pressure of 14 psi. Thus, in this implementation, the system 100 can define a showerhead of relatively small width and that produces a cloud of relatively consistent width-approximating the average width of adult human shoulders at a nominal distance below the body 130—substantially regardless of inlet pressure, such that most water discharged by the system 100 toward a user below engulfs the user; and such that little water discharged by the system 100 is projected far from the user's body and thus wasted.

### 4. Manifold and Flow Regulation

Therefore, the showerhead can include a pressure regulator 110 that functions to regulate a fluid supply to a target pressure (or to the lesser of the supply pressure and the target pressure) that is matched to types, geometries, and a distribution of nozzles within the showerhead in order to discharge droplets of a target size and at a target discharge speed within a greater curtain or cloud of a target geometry despite an unknown and possibly varying fluid supply pressure. The showerhead can further include a manifold 140 configured to distribute fluid from the outlet of the pressure regulator 110 to individual nozzles or to groups of nozzles, such as in described in U.S. patent application Ser. No. 15/895,913.

However, the showerhead can include nozzles of different types (e.g., flat-fan, hollow cone, and/or full cone) configured to discharge droplets of different target sizes and/or at different target speeds to form sprays of different geometries, as shown in FIGS. 3 and 4. Therefore, the showerhead can include flow restrictors 142 (e.g., orifice plates) interposed between the pressure regulator 110 and the set of nozzles 120 in order to further reduce pressure at the fluid inlets of these nozzles. In particular, once the pressure regulator 110 regulates water flowing into the manifold 140 down to a substantially constant target pressure from a substantially unlimited source (e.g., a water main within a building), a flow restrictor 142—arranged within the manifold 140 or along branches of the manifold 140 fluidly coupled to individual or groups of nozzles within the showerhead—can further reduce water pressure and flow to this individual nozzle or group of nozzles, thereby: increasing droplet size; reducing droplet speed; and/or reducing spray angle for droplets discharged from these nozzles.

In one example, the pressure regulator 110 is configured to regulate a fluid supply down to a target pressure equivalent to a sum of: a target inlet pressure for a particular nozzle, in the showerhead, designated for a greatest inlet pressure; and head loss between the pressure regulator 110 and the particular nozzle under operating conditions. In this example, the showerhead can thus further include orifice plates interposed between the pressure regulator 110 and each other nozzle in the showerhead in order to reduce inlet pressures at each of these nozzles to corresponding nozzle-specific target inlet pressures given the known, regulated outlet pressure of the pressure regulator 110. Therefore, the showerhead can include both the pressure regulator 110 and downstream flow restrictors 142 that cooperate to achieve a consistent, target inlet pressure at each nozzle in the showerhead and thus achieve a target distribution of droplet sizes and speeds within a greater target curtain or cloud geometry.

### 5. Showerhead: Nozzle Array

In the variation described above in which the pressure regulator 110, the set of nozzles 120, and the flow restrictors 142 are integrated into a showerhead, the set of nozzles 120 can include flat-fan, full cone, and/or hollow cone nozzles, as described in U.S. patent application Ser. Nos. 14/814,721 and 15/895,913. In this variation, the pressure regulator 110 can regulate a commercial or residential fluid supply-which may vary from an average of 20 psi to an average of 80 psi and vary by as much as 50% over time (e.g., responsive to other water use in the same structure-down to a target pressure of 25 psi). In this example, the showerhead can also: include orifices of a first size between the pressure regulator 110 and a set of flat-fan nozzles 126 arranged about a perimeter of the showerhead in order to reduce the spray angle of these flat-fan nozzles 126; include orifices of a second, smaller size between the pressure regulator 110 and a set of hollow cone nozzles in order to reduce the size of droplets discharged by these hollow cone nozzles; and omit a flow restrictor 142 between the pressure regulator 110 and a central full cone nozzle in order to maximize a spray angle and total volume flow rate through the central full cone nozzle given the output pressure of the pressure regulator 110.

In one variation, the showerhead includes a set of 6 full cone nozzles arranged in a circular pattern of maximum radius less than four inches about the body 130. However, the showerhead can include any number, type, and configuration of nozzles and can include any other configuration of flow restrictors 142—matched to the target pressure output by the pressure regulator 110—in order to achieve a dispersion of droplets of a target size, speed, and distribution despite the average pressure or variations in pressure of the fluid supply.

### 6. Showerhead: Mount

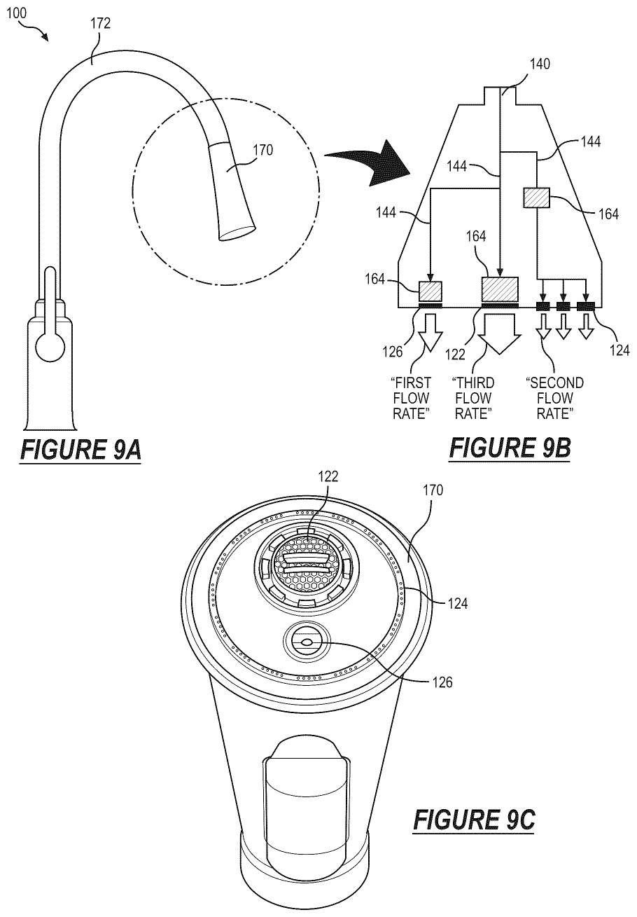

In the foregoing variation, the showerhead can be arranged on a mount 136: configured to support the showerhead over a range of vertical positions; and adjustable by manually lifting the showerhead (or the mount 136) upward or drawing the showerhead (or the mount 136) downward. In particular, the showerhead can discharge a curtain or droplet cloud of a geometry configured to envelop a user's head and shoulders; and the temperature of this curtain or droplet cloud may decrease with distance from the showerhead—as shown in FIG. 7. Therefore, the showerhead can be arranged on an adjustable mount 136 that enables a user to—quickly, with a single hand, and without tools—raise or lower the showerhead to a position over the user's head (e.g., 4-8 inches over the user's head) such that the curtain or droplet cloud envelops the user's head and shoulders and such that this curtain or droplet cloud exhibits a temperature that is comfortable for the user.

As described in U.S. patent application Ser. No. 15/673,310, the mount 136 can include: a wall element configured to fixedly couple to a wall, such as to a drop ear within a shower stall; an arm 138 coupled to and configured to translate vertically along the wall element and defining a distal end coupled to and supporting the showerhead; and a spring 146 element configured to impart a vertical force upward from the wall element to the arm 138 in order to counter the weight of the arm, the showerhead, and water contained within the showerhead and plumbing between the wall element and the showerhead.

Alternatively, the mount 136 can include: a ferrous (e.g., steel) wall element configured to fixedly couple to a wall of a shower stall; an arm 138 coupled to and configured to translate vertically along the wall element and defining a distal end coupled to and supporting the showerhead; and a magnetic element arranged in the arm, configured to magnetically couple to the wall element, and configured to retain the arm 138 against the wall element and permit the arm 138 to slip along the wall element when a user manually manipulates the showerhead or the arm, as shown in FIG. 2. However, the mount 136 can include any other elements or features to enable a user to easily, manually raise and lower the showerhead within a shower stall.

### 6.1 Showerhead: Fluid Pathway and Port Block

In the foregoing variation the pressure regulator 110 can be arranged remotely from the showerhead. For example, the pressure regulator 110 can be integrated into the wall mount 136 and located proximal the drop ear in the shower stall when the wall mount 136, arm, and showerhead are installed.

Alternatively, the pressure regulator 110 can be arranged in a port block separate and discrete from the wall element, and the port block can define one or more outlet ports fluidly coupled to the outlet of the pressure regulator 110, as shown in FIG. 2. In this implementation: the wall mount 136 can be mounted to a wall of the shower separately from the drop ear, such as with an adhesive, tape, or mechanical fastener; and the port block can be mounted to, near, or otherwise fluidly coupled to the drop ear and separate from the wall mount 136. In these implementations: a rigid or flexible water line-arranged internal or external the wall mount 136 and the arm 138—can distribute a pressure-regulated supply of water from the pressure regulator 110 (e.g., from an outlet port of the port block) to a fluid inlet 134 port on the showerhead; and a manifold 140 within the showerhead can distribute pressure-regulated water from the fluid inlet 134 port to the set of nozzles 120.

Yet alternatively: the pressure regulator 110 can be integrated into a body 130 of the showerhead (e.g., adjacent the fluid inlet 134 port of the showerhead); a rigid or flexible water line can distribute an unregulated supply of water from the drop ear to the pressure regulator 110 within the showerhead; and a manifold 140 within the showerhead can distribute pressure-regulated water from the pressure regulator 110 to the set of nozzles 120.

### 7. Wand

In one variation described in U.S. patent application Ser. No. 15/673,310 and shown in FIG. 2, the showerhead is paired with a separate wand 160 that includes a second set of nozzles 120 162.

In one example, the second set of nozzles 120 162 can be fluidly coupled to the same pressure regulator 110 as the showerhead and configured to discharge water droplets with an average kinetic energy less than droplets discharged by nozzles of the showerhead. In this example, the system 100 can include: a showerhead defining a first set of nozzles 120; and a wand 160 defining a second set of nozzles 120 162 configured to fluidly couple to the pressure regulator 110. In response to the pressure regulator 110 regulating water supplied at a first inlet pressure at the fluid inlet 134 down to a first internal pressure: the first set of nozzles 120 can discharge water droplets exiting the body 130 with kinetic energies in a first range of kinetic energies and in a first spray pattern extending from the body 130, defining a first width at a target distance from the showerhead, and exhibiting a first volumetric ratio of water to air; and the second set of nozzles 120 162 can discharge water droplets exiting the wand with kinetic energies in a third range of kinetic energies greater than the first range of kinetic energies and in a third spray pattern extending from the wand, defining a third width less than the first width at the target distance from the wand 160, and exhibiting a third volumetric ratio of water to air less than the first volumetric ratio of water to air. Therefore, in this example, water droplets discharged by the wand 160 can exhibit higher average kinetic energy than droplets discharged by the showerhead. The wand 160 can be manipulated by a user in a bathing environment to selectively rinse more specific regions of her body. For example, the second set of nozzles 120 162 in the wand 160 can be configured to discharge larger water droplets at higher exit velocities in order to achieve higher kinetic energies thus increase rinsing efficacy when the wand 160 is manipulated by a user to rinse soap from a particular region of her body.

In one implementation, the wand 160: includes a hose configured to tap into a pressure-regulated output of the pressure regulator 110; and is configured to pivotably and transiently couple to a wand mount installed on a wall of a shower stall. For example, the wand mount can include a magnetic element arranged inside of a body defining a convex or concave surface. In this example, a body of the wand 160 can be fabricated (e.g., stamped) from sheet steel to define a concave or convex surface configured to mate with the like surface of the wand mount and can magnetically couple to the magnetic element within the wand mount to retain the wand 160 on the wand mount when not held by a user. In a similar example: the wand mount can be stamped, formed, or drawn from a sheet of a ferrous material; and a magnetic element can be arranged inside the wand body and configured to magnetically couple to the ferrous body of the wand mount, thereby retaining the wand 160 on the wand mount.

In the implementation described above in which the showerhead includes a port block, the pressure regulator 110 can be integrated into the port block, and the port block can define a set of pressure-regulated outlet ports, each fluidly coupled to the outlet of the pressure regulator 110. Each outlet port can also include a quick-connect fitting, such as a self-sealing quick-connect female fitting. To connect the wand 160 to the port block, a user may thus insert a quick-connect fitting (e.g., a quick-connect male fitting) on the end of the hose of the wand 160 into an outlet port of the port block, which may then supply pressure-regulated water to the second set of nozzles 120 162 in the wand 160.

Alternatively, in the implementation described above in which the pressure regulator 110 is integrated into the wall mount 136, a wand 160 port can be arranged in the wall mount 136 and can tap into an outlet of the pressure regulator 110. The wand 160 can thus be fluidly coupled to the pressure-regulated output of the pressure regulator 110 by connecting the hose of the wand 160 to the wand 160 port on the wall mount 136.

In this variation, the wand 160 can include a valve: operable in a closed position to block fluid flow from the hose to the second set of nozzles 120 162 in the wand 160; and operable in an open position to pass fluid from the hose to the second set of nozzles 120 162. (The showerhead or arm 138 can similarly include a valve configured to selectively enable or disable fluid flow to all or a subset of nozzles 120 in the showerhead.) Alternately, the port block can include one actuatable valve interposed between the pressure regulator 110 and an outlet port for each outlet port in the port block, as shown in FIG. 2; and a user may thus selectively open or close a valve at an output port coupled to the hose of the wand 160 in order to enable or disable flow through the wand 160. (The user may similarly selectively open or close a valve at an output port coupled to the hose of the showerhead in order to enable or disable flow through all or a subset of nozzles 120 in the showerhead.)

### 8. Modular Assembly

In one variation shown in FIG. 2, the showerhead is a component in a kit of elements that includes: a port block containing the pressure regulator 110 and multiple (e.g., three or more) outlet ports fluidly coupled to the pressure regulator 110, as described above; a set (i.e., one or more) of showerheads, such as coupled to fixed or adjustable mounts 136, as described above; and a set of wands 160 paired with wand mounts configured to transiently and adjustably couple to and support the set of wands.

In this variation, a user may acquire the port block and one showerhead, install the port block in-line with a drop ear in her home shower, attach the wall mount 136 and the showerhead to the wall of the shower stall, and connect the showerhead to the first outlet port of the port block with a flexible hose. Later, the user may acquire a wand 160 and wand mount, attach the wand mount to a wall in her shower stall, and connect the hose of the wand 160 to the second outlet port of the port block. Over time, the user may develop a preference for the wand 160 over the showerhead and therefore: acquire a second wand 160 and second wand mount and a third wand 160 and third wand mount; remove the showerhead from the shower stall and port block; attach the second and third wand mounts to the wall at different positions within her shower stall (e.g., with the first, second, and third wand mounts arranged at height of the user's face, upper torso, and lower torso within the shower stall); and connect the hoses of the second and third wands to the first and third outlet ports of the port block. The port block can thus supply pressure-regulated water to each of these three wands 160. Later, the user can reinstall the showerhead in the shower stall and can reconnect the showerhead to a fourth port on the port block and/or move the wand mounts to different walls and/or different heights within the shower stall to achieve a different, personalized shower experience.

### 9. Nozzle Manufacture

The showerhead can include a lower body 130 section and an upper body 130 section that are assembled (e.g., bonded, heat-staked, welded) to form the manifold 140 (i.e., a fluid pathway) extending from a fluid inlet 134 port fluidly coupled to the pressure regulator 110 to the set of nozzles 120 as shown in FIG. 4. In one implementation, the lower body 130 section of the showerhead defines a set of discrete nozzle ports at target locations of nozzles (e.g., at the end of each leg of the manifold 140), such as described in U.S. patent application Ser. No. 15/895,913. In this implementation, each nozzle can define a complete nozzle element configured to be threaded, clamped, bonded, or otherwise fastened to a corresponding nozzle port in the lower body 130 section of the showerhead. For example, the lower body 130 section of the showerhead can define a set of threaded nozzle ports fluidly coupled to the manifold 140. In this example, a user may: select from a set of discrete nozzles of different types and exhibiting different droplet sizes and discharge speeds as a function of nozzle inlet pressure; and install these discrete nozzles in threaded nozzle ports in the lower body 130 section, thereby personalizing the showerhead. In this example, the manifold 140 inside the showerhead can be configured to yield substantially uniform head loss between the fluid inlet 134 port and each threaded bore, and each discrete nozzle can include an integrated flow restrictor configured to reduce pressure into the nozzle inlet in order to match size, speed, and distribution of droplets discharged from the nozzle to a known pressure within the manifold 140 during typical operation.

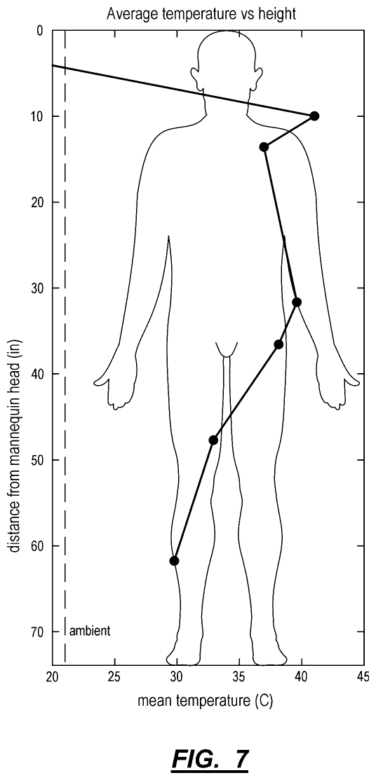

Alternatively, the lower body 130 section can define a nozzle orifice at each nozzle location (e.g., at the end of each leg of the manifold 140), and the lower and upper body 130 sections can be configured to receive a nozzle component insert at each nozzle orifice location in order to complete each nozzle, as shown in FIG. 5. In this implementation, each nozzle component insert can define a geometry configured to yield a corresponding spray geometry—as shown in FIG. 4—such as: a swirl chamber insert for a full cone nozzle; and a swirl plate for a hollow cone nozzle. For example: each nozzle component insert can define a cylindrical body 130; the lower body 130 section can define a cylindrical counterbore centered over each nozzle orifice; and the upper body 130 section can define a tongue (or similar feature) aligned with the counterbore in the lower body 130 section and configured to depress and retain a nozzle component insert into the adjacent counterbore when the upper body 130 section is assembled over the lower body 130 section. Additionally or alternatively, a nozzle component insert can be bonded, welded, or threaded into a bore, insert seat, or other feature over a corresponding nozzle orifice in the lower body 130 section. Therefore, the lower body 130 section can define the nozzle orifice of a full or hollow cone nozzle in the showerhead, and the showerhead can include a nozzle component insert that cooperates with the nozzle orifice to complete a nozzle. Furthermore, in this implementation, a flat-fan nozzle 126 can be manufactured (e.g., formed, molded) directly into the lower body 130 section of the showerhead, such as with a semi-spherical or paraboloid feature formed on the interior-side of the lower body 130 section and a v-notched feature formed on the exterior-side of the lower body 130.

In the foregoing implementation, the lower body 130 section (and the upper body 130 section) can be manufactured with a nozzle orifice in situ. For example, the lower body 130 section-including manifold features, nozzle component insert bores or seats, and nozzle orifices—can be injection molded in a polymer (e.g., a thermoset or thermoform plastic) in a single operation; the lower body 130 section can then be trimmed, nozzle component inserts can be located (and bonded) over their corresponding seats, and the upper body 130 section (which may be similarly injection molded) can be assembled over the lower body 130 section (e.g., by welding, bonding, or heat-staking). Alternatively, the lower body 130 section can be injection molded with nozzle orifice features and then post machined (e.g., in a CNC drilling or milling machine) to drill or machine nozzle orifices through the nozzle orifice features before the nozzle component inserts are loaded onto their seats and the upper body 130 section installed. In these implementations, a nozzle component insert can be injection molded, machined, or otherwise manufactured. By thus separating manufacture of the nozzle orifices from the nozzle component inserts, the showerhead may be completed with tight relative locational tolerances across the array of nozzle orifices; while also enabling production of the nozzle component inserts-which may be dimensionally much smaller than the lower body 130 section—with very tight tolerances, which may thus enable both tight control over droplet sizes, speeds, and spray patterns from these completed nozzles and reduce manufacture and assembly costs for the showerhead.

In one implementation in which the showerhead includes both flat-fan nozzles 126 and hollow and/or full cone nozzles, the lower body 130 section of the showerhead can: define nozzle orifices and a nozzle component insert seat at each hollow and/or full cone position; and define a nozzle seat configured to receive a complete nozzle at each flat-fan position. Therefore, in this implementation, the lower body 130 section: can define nozzle orifices and locate nozzle component inserts at some nozzle positions; and can receive separate, complete (e.g., threaded) nozzles at other nozzle positions, such as at positions of nozzles defining primary axes non-normal to an injection-molding parting axis of the lower body 130 section.

However, the lower body 130 section can define a set of nozzle features and/or can be configured to receive separate, complete nozzles in any other way. Furthermore, the showerhead can include one or multiple body 130 sections manufactured and assembled in similar or other ways and in any other material to form a manifold 140 configured to fluidly couple a fluid inlet 134 port (or the pressure regulator 110 directly) to a set of nozzles 120. The wand 160 can be similarly configured and manufactured with discrete or integrated nozzles.

### 10. Faucet

In one variation shown in FIGS. 9A-9C and 10A-10C, the set of nozzles 120 and flow restrictors 142 are integrated into a faucet 100.

The faucet 100 includes: a housing 172 including a fluid inlet 134 fluidly coupled to a fluid supply (e.g., a water main at a kitchen sink) and a distal end opposite the fluid inlet; a set of nozzles 120 arranged on the distal end of the housing 172 and configured to dispense water according to according to a user-selected spray pattern; a fluid supply (e.g., hot and cold) valve arranged in the faucet 100 and configured to regulate the temperature and flow of fluid to the faucet 100; a set of nozzle and flow restrictor pairs arranged in the faucet 100 head configured to adjust the water flow rate and spray pattern based on the selected nozzle; a set of valves arranged in the faucet 100 head and configured to selectively pass water from the fluid supply valve to the set of nozzle and flow restrictor pairs; a momentary button 150 arranged on the housing 172 and configured to transition a momentary shutoff valve 152 between positions to selectively pass fluid from the fluid supply to the set of nozzles 120; and a flow selector button 158 arranged on the housing 172 and configured to transition a primary flow selector valve 174 and a secondary flow selector valve 184 to selectively pass water to the set of nozzles 120.

### 10.1 Faucet Variation: Quad-mode Faucet Operation from Two Buttons

In one variation, the faucet 100 includes: a housing 172 including a fluid inlet 134 fluidly coupled to a fluid supply; a cavity 148 fluidly coupled to and downstream of the fluid inlet 134; a momentary shutoff valve 152 fluidly coupled to and interposed between the fluid inlet 134 and the cavity 148 and configured to pass fluid from the fluid inlet 134 into the cavity 148 in an open mode and block passage of fluid from the fluid inlet 134 into the cavity 148 in a closed mode; a first spring 146 configured to bias the momentary shutoff valve 152 in the open mode; and a momentary button 150 arranged on the housing 172 and configured to transition the momentary shutoff valve 152 between the open mode and the closed mode.

In this variation, the faucet 100 further includes: an aerator nozzle 122 arranged on a distal end of the housing 172; a soft-flow nozzle 124 arranged on the distal end of the housing 172 adjacent the aerator nozzle 122; and a flat-fan nozzle 126 arranged on the distal end of the housing 172 adjacent the soft-flow nozzle 124 and the aerator nozzle 122.

In this variation, the faucet 100 also includes a primary flow selector valve 174: fluidly coupled to and downstream of the cavity 148; and including a primary valve seat 178 and a primary piston 176. The primary piston 176 is unseated from the primary valve seat 178 in an aerated mode to: pass fluid from the cavity 148 to the aerator nozzle 122; and block passage of fluid from the cavity 148 to a secondary flow selector valve 184. Additionally, the primary piston 176 is seated on the primary valve seat 178 in an intermediate mode to: pass fluid from the cavity 148 to the secondary flow selector valve 184; and block passage of fluid from the cavity 148 to the aerator nozzle 122.

In this variation, the faucet 100 further includes: a second spring 146 configured to bias the primary piston 176 in the aerated mode; and the secondary flow selector valve 184 fluidly coupled to and downstream of the primary flow selector valve 174 and including a secondary valve seat 188 and a secondary piston 186. The secondary piston 186 is unseated from the secondary valve seat 188 in a soft-flow mode to: pass fluid from the primary flow selector valve 174, in the intermediate mode, to the soft-flow nozzle 124; and block passage of fluid from the primary flow selector valve 174, in the intermediate mode, to the flat-fan nozzle 126. Additionally, the secondary piston 186 is seated on the secondary valve seat 188 in a flat-fan mode to: pass fluid from the primary flow selector valve 174, in the intermediate mode, to the flat-fan nozzle 126; and block passage of fluid from the primary flow selector valve 174, in the intermediate mode, to the soft-flow nozzle 124.

In this variation, the faucet 100 also includes: a third spring 146 configured to bias the secondary flow selector valve 184 in the soft-flow mode; and a shaft 166 coupled to the secondary piston 186. The shaft 166 is operable in: a first position locating the secondary piston 186 in the flat-fan mode; and a second position locating the secondary piston 186 in the soft-flow mode. The shaft 166 includes a distal end configured to drive the primary piston 176 from the aerated mode into the intermediate mode during transition of the shaft 166 from the first position into the second position.

In this variation, the faucet 100 further includes a flow selector button 158: arranged on the housing 172; coupled to the shaft 166; and configured to transition the shaft 166 between the first position and the second position.

### 10.2 Applications

Generally, the faucet 100 is configured to operate in four modes, including: an off mode; an aerated mode (e.g., for filling with a low-splash cylindrical stream); a soft-flow mode (e.g., for gentle rinsing); and a flat-fan mode (e.g., for high-coverage sheet spray, for scraping food from dishes).

In particular, the faucet 100 is configured to transition between these modes responsive to user input at a momentary shutoff button and a flow selector button. More specifically, in the aerated mode, the faucet 100 directs fluid through the aerator nozzle 122 to maximize flow rate in a coherent, aerated stream, such that the faucet 100 fills a glass, pot, or sink quickly while minimizing splash. In the soft-flow mode, the faucet 100 directs fluid through the soft-flow nozzle 124 to reduce the flow rate and generate a dispersed droplet pattern (e.g., a hollow-cylinder spray pattern) that fully wets a user's hands. In this mode, the faucet 100 provides a comfortable and thorough rinsing effect despite a lower volumetric flow rate. Additionally, in the flat-fan mode, the faucet 100 directs fluid through the flat-fan nozzle 126 to generate a laterally spread, high-velocity sheet of water. In this mode, the faucet 100 produces a narrow but forceful spray that is effective for removing food debris from dishes. Additionally, in the off mode, the faucet 100 interrupts inlet flow to temporarily disable discharge. In this mode, the faucet 100 enables the user to rapidly stop flow with a single hand while manipulating the faucet 100, thereby reducing unintended water spray and conserving water.

The faucet 100 achieves these modes with a set of components arranged within a housing 172 of the faucet and including: a momentary shutoff valve 150 configured to toggle between on and off modes; a rocker switch 164 configured to drive a shaft 166 that repositions the primary piston 176 in a single direction and the secondary piston 186 in two directions; and flow selector valves that rely on fluid pressure acting on opposing sides of each piston to hold the valves in specific positions during continuous flow. Additionally, the faucet 100 includes springs that bias the pistons back to nominal positions (e.g., aerated mode) when water flow is disabled at the fluid supply valve or at the momentary shutoff valve 152.

In particular, the faucet 100 includes a combination of nozzles and flow restrictors 142 that cooperate to discharge water droplets within a narrow range of target sizes (e.g., diameters) and within a narrow range of target speeds within a greater curtain or droplet cloud of a particular target geometry matched to a particular washing or rinsing experience (e.g., a particular feeling of “wetness” and warmth) while limiting water consumption. In this variation, the faucet 100 includes: a housing 172 including a fluid inlet 134 fluidly coupled to a fluid supply; a set of nozzles 120 including an aerator nozzle 122 (e.g., for filling with a low-splash cylindrical stream), a soft-flow nozzle 124 (e.g., for gentle rinsing), and a flat-fan nozzle 126 (e.g., for high-coverage sheet spray); a set of flow restrictors that cooperate with the nozzles to maintain consistent spray geometry across variations in supply pressure; a set of flow selector valves that cooperate to selectively route fluid to the aerator nozzle 122, soft-flow nozzle 124, or flat-fan nozzle 126; and a flow selector button 158 arranged on the housing 172 and configured to selectively actuate the set of flow selector valves responsive to user input.

### 10.2.1.1 Spray Mode Selection

In particular, the faucet 100 includes: a primary flow selector valve 174 fluidly coupled to and downstream of the fluid inlet; and a secondary flow selector valve 184 fluidly coupled to and downstream of the primary flow selector valve 174. Each flow selector valve includes a valve seat and a piston. In one application, the faucet 100 is configured to transition between spray modes responsive to user inputs at the flow selector button 158. In particular, a user input can be transmitted through a shaft 166, arranged within the housing 172, to mechanically reposition the pistons, while fluid pressure acting on opposing faces of the pistons maintains positions of these pistons during continuous flow. Accordingly, the faucet 100 can include a set of two pistons configured to operate the faucet 100 in three distinct spray modes without dedicated actuators for each nozzle, thereby reducing parts and space requirements for the faucet 100.

In one application, the faucet 100 routes fluid directly to the aerator when the primary piston 176 is displaced from the primary valve seat 178 (i.e., in aerated mode). In particular, in aerated mode, the faucet 100 directs fluid from the fluid inlet 134, through the cavity 148, and through an aerated flow pathway in the primary flow selector valve 174 to the aerator nozzle 122, while blocking passage of fluid to the secondary flow selector valve 184. In particular, the faucet 100 relies on fluid pressure acting on a downstream-facing surface of the primary piston 176 to maintain the piston in this unseated position during continuous flow to maintain a stable, low-splash stream, such as for filling tasks.

In another application, the faucet 100 diverts fluid toward the secondary valve when the primary piston 176 is seated on the primary valve seat 178 (i.e., in intermediate mode). In particular, in intermediate mode, the faucet 100 directs fluid from the fluid inlet 134, through the cavity 148, and into the secondary flow selector valve 184, while blocking passage of fluid to the aerator nozzle 122. In particular, the faucet 100 relies on fluid pressure acting on an upstream-facing surface of the primary piston 176 to maintain the piston in this seated position during continuous flow. Furthermore, the faucet 100 includes a second spring 146 that biases the primary piston 176 toward the aerated mode, such that loss of flow resets the faucet 100 to aerated mode. This spring bias ensures that the faucet 100 reopens in a predictable, low-splash configuration, even after mode changes, such as to prevent unintended lateral spray on startup.

In another application, the faucet 100 diverts fluid toward the soft-flow nozzle 124 when the secondary piston 186 is unseated from the secondary valve seat 188, thereby blocking the flat-fan flow path. Alternatively, the faucet 100 diverts fluid toward the flat-fan nozzle 126 when the secondary piston 186 is seated against the secondary valve seat 188, thereby blocking the soft-flow flow path. The faucet 100 maintains the secondary piston 186 in either position through fluid pressure acting on opposing faces of the secondary piston 186, such that the faucet 100 maintains the selected spray mode without mechanical latching and with minimal user effort.

Accordingly, the faucet 100 leverages fluid pressure as an active holding force on the primary and secondary piston to maintain spray mode stability during operation. In each mode, hydraulic forces on the piston faces counteract spring 146 forces to hold the piston in the commanded position until flow stops and the springs return the pistons to each default orientation. Therefore, the faucet 100 reduces mechanical complexity, eliminates separate mode-locking mechanisms, and maintains consistent mode performance across a range of inlet pressures.

In one application, the faucet 100 includes a momentary shutoff valve 152 and a momentary button 150 configured to interrupt inlet flow on demand. The faucet 100 interrupts inlet flow on demand, and removal of hydraulic force allows the springs 146 to re-establish the aerated default mode before the next actuation. Accordingly, the momentary button 150 can be depressed by the user to temporarily pause water flow, such as when repositioning cookware, to reduce water waste and/or reset the faucet 100 to aerated mode.

Accordingly, the faucet 100 implements the flow selector valves to route water between the aerator, soft-flow, and flat-fan nozzles while relying on fluid pressure and spring bias to maintain or reset piston positions without the need for separate actuators for each outlet. Additionally, the faucet 100 coordinates the flow selector valves with the momentary shutoff valve 152 such that interrupting flow removes hydraulic holding forces and returns the system to the aerated default, such as to initiate a predictable and low-splash operation at the next use. Furthermore, by leveraging fluid pressure and reducing part quantity and required space for faucet components, the faucet 100 can integrate the flow selector valves with nozzle-specific flow restrictors within the spray head. By integrating the flow selector valves with nozzle-specific flow restrictors, the faucet 100 can maintain consistent spray geometry and flow rates across modes despite supply pressure variation. Therefore, the faucet 100 is configured to discharge water droplets according to three distinct spray modes from a compact head assembly while reducing mechanical complexity, preserving internal space for per-nozzle flow conditioning, and maintaining stable, repeatable performance across a wide range of operating conditions.

### 10.3 Nozzles+Flow Restrictors

In one implementation, the faucet 100 includes: a set of nozzles 120, each nozzle operable for a different function, such as removal of food waste from dishes, quickly filling a sink and/or pot, hand washing, and rinsing produce; and a set of flow restrictors, each flow restrictor corresponding to a particular nozzle and configured to limit the flow of water to the corresponding nozzle and to regulate the pressure drop across and/or flow rate through the nozzle falls with the operating pressure or target flow rate of the nozzle. In particular, the faucet 100 includes: an aerator nozzle 122 arranged on a distal end of the housing 172; a soft-flow nozzle 124 arranged on the distal end of the housing 172 adjacent the aerator nozzle 122; and a flat-fan nozzle 126 arranged on the distal end of the housing 172 adjacent the soft-flow nozzle 124 and the aerator nozzle 122. The faucet 100 can include the set of flow restrictors arranged upstream the set of nozzles 120 and configured to discharge water droplets of different target sizes and/or at different target speeds to form sprays of different geometries, as discussed below.

In particular, the set of flow restrictors can be arranged along different branches of a manifold, fluidly coupling the fluid inlet to the set of nozzles 120, and fluidly coupled to a corresponding nozzle within the faucet 100 (e.g., via a rigid or flexible water line). For example, the faucet 100 can include: a first flow restrictor fluidly coupled to the aerator nozzle 122 and arranged along a first branch 144 of the manifold 140; a second flow restrictor fluidly coupled to the soft-flow nozzle 124 and arranged along a second branch 144 of the manifold 140; and a third flow restrictor fluidly coupled to the flat-fan nozzle 126 and arranged along a third branch 144 of the manifold 140. Furthermore, each flow resistor can be positioned upstream the corresponding nozzle to match sizes, speeds, and distributions of water droplets discharged from the set of nozzles 120 to a target spray pattern experience. Accordingly, the faucet 100 can include different nozzle and flow restrictor configurations to address specific requirements for filling, hand washing, and dish rinsing to reduce water consumption per faucet by delivering the necessary volume flow rate of water in a format (e.g., continuous flow or droplet cloud) configured for the particular task selected by the user.

### 10.3.1 Aerator Nozzle

In one implementation, the faucet 100 includes an aerator nozzle 122 (e.g., a high-volume flow rate nozzle) configured to dispense water droplets exhibiting an aerated spray pattern, such as for rapidly filling a pot or a sink. In particular, the aerator nozzle 122 includes: a circular aperture configured to discharge water droplets exhibiting the aerated spray pattern; and an aerator arranged over the circular aperture and configured to mix air with water exiting the aerator nozzle 122.

In one implementation, the aerator nozzle 122 cooperates with a flow restrictor 142 arranged upstream of the aerator nozzle 122 (e.g., interposed between the primary flow selector valve 174 and the aerator nozzle 122). In particular, the aerator nozzle 122 cooperates with the flow restrictor 142 to achieve an aerated spray pattern exhibiting a set of target characteristics (e.g., a target flow rate, a target droplet size, a target distribution, a target velocity). For example, the aerator nozzle 122 cooperates with the flow restrictor 142 to discharge water droplets from the faucet 100 in the aerated spray pattern exhibiting a target flow rate (e.g., ≤1.5 GPM). Thus, the aerator nozzle 122 cooperates with the flow restrictor 142 to limit the water flow to the aerator nozzle 122, such that the pressure drop and flow rate of the aerator nozzle 122 adjust to the operating pressure or flow rate, thereby translating into a “pleasant” experience for a user, including yielding perceptions of “efficiency,” and “speed.”

In one variation, the aerator nozzle 122 can be removed from the housing 172 and replaced with a laminar flow nozzle. In this variation, the faucet 100 discharges water through a circular aperture of the laminar flow nozzle without air entrainment, such that the faucet 100 delivers a solid stream of water droplets exhibiting a laminar flow pattern (i.e., rather than an aerated spray pattern). In this variation, the faucet 100 can allow the user to select between the aerator nozzle 122 for higher perceived volume and reduced splash, or the laminar flow nozzle for a smooth, quiet stream, while relying on the same valve and flow restrictor arrangement to regulate flow characteristics.

### 10.3.2 Soft-Flow Nozzle

In one implementation, the faucet 100 includes a soft-flow nozzle 124 (e.g., a hand washing nozzle) configured to dispense water droplets exhibiting a hollow-cylinder spray pattern that balances rinsing efficacy, warmth, and droplet sensation such that a user may efficiently wet and wash her hands, or gently and effectively rinse produce (e.g., berries, vegetables). In particular, the soft-flow nozzle 124 includes a set of apertures: arranged radially about a perimeter of the distal end of the housing 172; and configured to discharge water droplets exhibiting the hollow-cylinder spray pattern.

In one implementation, the soft-flow nozzle 124 cooperates with a flow restrictor 142 arranged upstream of the soft-flow nozzle 124. In particular, the soft-flow nozzle 124 cooperates with the flow restrictor 142 to achieve a hollow-cylinder spray pattern exhibiting a set of target characteristics (e.g., a target flow rate, a target droplet size, a target distribution, a target velocity). For example, the soft-flow nozzle 124 cooperates with the flow restrictor 142 to discharge water droplets from the faucet 100 in the hollow-cylinder spray pattern exhibiting a target flow rate (e.g., 0.4-1.0 GPM). More specifically, the soft-flow nozzle 124 can be configured to discharge water droplets forming a cloud of water droplets in the hollow-cylinder spray pattern that balances rinsing efficacy, warmth, and droplet sensation, such as for a user to efficiently wet and wash her hands or rinse produce. In particular, a flow rate exceeding the target flow rate for the soft-flow nozzle 124 can result in smaller, faster droplets that exhibit a wider distribution, thus resulting in a harsh spray causing a stinging sensation to the user or damaging (e.g., bruising) produce, and/or an uncontrollable or undesirable spray (e.g., to the torso of the user). Conversely, a flow rate falling below the target flow rate can result in slower droplets exhibiting a narrower distribution, thus resulting in an inefficient hand washing or produce rinsing experience.

Accordingly, the soft-flow nozzle 124 can cooperate with the flow restrictor 142 to limit the water flow to the soft-flow nozzle 124 such that the pressure drop across and the flow rate through the soft-flow nozzle 124 adjust to the operating pressure or flow rate, thereby translating into a “pleasant” washing and/or rinsing experience for a user, including yielding perceptions of “warmth,” “softness,” “fullness,” and “wetness” and resulting in an efficient hand washing or produce rinsing experience.

### 10.3.3 Flat-Fan Nozzle

In one implementation, the faucet 100 includes a flat-fan nozzle 126 (i.e., a dish washing nozzle) configured to dispense water droplets exhibiting a flat-fan spray pattern, such as for effectively breaking and removing food from a dish while limiting consumption of water at the faucet 100 during the rinse process. In particular, the flat-fan nozzle 126 includes a rectilinear aperture: arranged on the distal end of the housing 172 inset from the soft-flow nozzle 124 adjacent the aerator nozzle 122; and configured to discharge water droplets exhibiting the flat-fan spray pattern.

In one implementation, the flat-fan nozzle 126 cooperates with a flow restrictor 142 arranged upstream of the flat-fan nozzle 126 (e.g., interposed between the secondary flow selector valve 184 and the flat-fan nozzle 126). In particular, the flat-fan nozzle 126 cooperates with the flow restrictor 142 to achieve the flat-fan spray pattern exhibiting a set of target characteristics (e.g., a target flow rate, a target droplet size, a target distribution, a target velocity). For example, the flat-fan nozzle 126 cooperates with the flow restrictor 142 to discharge water droplets from the faucet 100 in the flat-fan spray pattern exhibiting a target flow rate (e.g., 0.5-0.8 GPM). More specifically, the flat-fan nozzle 126 can be configured to discharge water droplets (e.g., sheets of droplets) forming a high-energy (e.g., high-velocity) flat-fan spray pattern for high-efficiency removal of food waste from dishes. For example, the flat-fan spray pattern can exhibits large droplets (e.g., 300 microns in average diameter) moving at high speed and forming a narrow spray (e.g., ¼″ in width) spanning a target length that corresponds to a common dish size at a typical working distance between the distal end of the housing 172 and a dish (e.g., a target fan length of 6″ at a distance of 8″ from an average dinner and salad dish 9″ in diameter).

In particular, a flow rate exceeding the target flow rate can result in smaller, faster droplets in a wider distribution, thus reducing control during the dishwashing process and resulting in an uncontrollable or undesirable spray (e.g., to the torso of the user). Conversely, a flow rate falling below the target flow rate can result in larger, slower droplets in a narrower distribution, thus leading to insufficient water flow for effective rinsing. Thus, the first flow restrictor can limit the water flow to the flat-fan nozzle 126, such that the pressure drop across and first flow rate through the flat-fan nozzle 126 adjust to the operating pressure or flow rate, thereby effectively breaking down and removing food from a dish while limiting consumption of water at the faucet 100 during the rinse process.

### 10.4 Momentary Shutoff Valve+Momentary Button

In one implementation, the faucet 100 includes a momentary button 150 configured to inhibit passage of fluid from the fluid inlet to the set of nozzles 120. More specifically, the momentary button 150 can depress responsive to user input, such that the user may temporarily pause discharge of fluid from the set of nozzles 120.

In particular, the faucet 100 includes: a cavity 148 fluidly coupled to and downstream of the fluid inlet; and a momentary shutoff valve 152 fluidly coupled to and interposed between the fluid inlet and the cavity 148. The momentary shutoff valve 152 is configured to: pass fluid from the fluid inlet into the cavity 148 in an open mode; and block passage of fluid from the fluid inlet into the cavity 148 in a closed mode. The faucet 100 further includes: a spring 146 configured to bias the momentary shutoff valve 152 in the open mode; and the momentary button 150 arranged on the housing 172 and configured to transition the momentary shutoff valve 152 between the open mode and the closed mode.

### 10.5 Flow Selector Valves

In one implementation, the faucet 100 includes a set of flow selector valves that cooperate to selectively route fluid between the aerator nozzle 122, soft-flow nozzle 124, and flat-fan nozzle 126. In particular, the faucet 100 includes: a primary flow selector valve 174 fluidly coupled to and downstream of the cavity 148; and a secondary flow selector valve 184 fluidly coupled to and downstream of the primary flow selector valve 174. More specifically, the primary piston 176 and the secondary piston 186 cooperate to discharge distinct water droplet configurations without requiring separate dedicated actuators for each nozzle. More specifically, the primary piston 176 regulates whether fluid is routed directly to the aerator nozzle 122 or diverted toward the secondary flow selector valve 184, while the secondary piston 186 regulates whether diverted flow is directed to the soft-flow nozzle 124 or the flat-fan nozzle 126.

The primary flow selector valve 174 includes: a primary valve seat 178; and a primary piston 176 configured to transition between an aerated mode (e.g., supplying fluid to the aerator nozzle 122) and an intermediate mode (e.g., blocking passage of fluid to the aerator nozzle 122). In particular, the primary piston 176 is unseated from the primary valve seat 178 in an aerated mode to: pass fluid from the cavity 148 to the aerator nozzle 122; and block passage of fluid from the cavity 148 to the secondary flow selector valve 184. Additionally, the primary piston 176 is seated on the primary valve seat 178 in an intermediate mode to: pass fluid from the cavity 148 to the secondary flow selector valve 184; and block passage of fluid from the cavity 148 to the aerator nozzle 122. Additionally, the faucet 100 can further include a spring 146 configured to bias the primary piston 176 in the aerated mode. In particular, the spring 146 can bias the primary piston 176 in the aerated mode such that the faucet 100 automatically returns into the aerated mode when fluid flow is interrupted.

The secondary flow selector valve 184 includes: a secondary valve seat 188; and a secondary piston 186 configured to transition between a soft-flow mode (e.g., supplying fluid to the soft-flow nozzle 124) and a flat-fan mode (e.g., supplying fluid to the flat-fan nozzle 126). In particular, the secondary piston 186 is unseated from the secondary valve seat 188 in a soft-flow mode to: pass fluid from the primary flow selector valve 174, in the intermediate mode, to the soft-flow nozzle 124; and block passage of fluid from the primary flow selector valve 174, in the intermediate mode, to the flat-fan nozzle 126. Additionally, the secondary piston 186 is seated on the secondary valve seat 188 in a flat-fan mode to: pass fluid from the primary flow selector valve 174, in the intermediate mode, to the flat-fan nozzle 126; and block passage of fluid from the primary flow selector valve 174, in the intermediate mode, to the soft-flow nozzle 124. Additionally, the faucet 100 can further include a spring 146 configured to bias the secondary flow selector valve 184 in the soft-flow mode. In particular, the spring 146 can bias the secondary flow selector valve 184 in the soft-flow mode when fluid pressure is not actively acting on the secondary piston 186 (e.g., transitioning the secondary piston 186 into the flat-fan mode), such that the faucet 100 can rapidly and repeatably switch between soft-flow and flat-fan modes with minimal mechanical movement.

### 10.6 Shaft+Flow Selector Button

In one implementation, the faucet 100 further includes: a shaft 166 configured to mechanically interface with the primary piston 176 and the secondary piston 186 to drive transitions between spray modes; and a flow selector button 158 coupled to the shaft 166 and configured to reposition the shaft 166 between discrete positions corresponding to different piston configurations. In particular, the shaft 166 is operable in: a first position locating the secondary piston 186 in the flat-fan mode; and a second position locating the primary piston 176 and the secondary piston 186 in the soft-flow mode.

The shaft 166 includes: a proximal end coupled to the flow selector button 158; and a distal end configured to transiently seat within the primary piston 176. In particular, the distal end is configured to seat within and drive the primary piston 176 from the aerated mode into the intermediate mode during transition of the shaft 166 from the first position into the second position. More specifically, the distal end is configured to engage (e.g., contact) the primary piston 176, unseated from the primary valve seat 178 in the aerated mode, and drive the primary piston 176 toward the primary valve seat 178 to transition the primary piston 176 from the aerated mode into the intermediate mode. Furthermore, the shaft 166 is coupled to the secondary piston 186 (e.g., via a set of clips) and is configured to drive the secondary piston 186 to transition the secondary piston 186 from the soft-flow mode, with the secondary piston 186 unseated from the secondary valve seat 188, into the flat-fan mode with the secondary piston 186 seated on the secondary valve seat 188.

The flow selector button 158 is: arranged on the housing 172; coupled to the shaft 166; and configured to transition the shaft 166 between the first position and the second position. In one example, the flow selector button 158 includes a rocker 164 switch configured to pivot in opposite directions about a central axis to drive the shaft 166 between the first position and the second position. In particular: depressing the rocker 164 switch in a first direction positions the shaft 166 to maintain the secondary piston 186 in the flat-fan mode position; and depressing the rocker 164 switch in a second direction repositions the shaft 166 to locate both the primary piston 176 in the intermediate mode and the secondary piston 186 in the soft-flow mode position.

### 10.7 Spray Modes and Transitions

In one implementation, as shown in FIGS. 10A-10C, the faucet 100 is configured to selectively operate in aerated mode, soft-flow mode, and flat-fan mode, and transition between these modes responsive to user inputs at a momentary button 150 and a flow selector button 158. In particular, a user input may mechanically reposition the pistons, and fluid pressure acting on opposing faces of the pistons can maintain piston placement during operation. Because the distal end of the shaft 166 (i.e., coupled to the flow selector button 158) is not coupled to the primary piston 176, the primary piston 176 can be positioned by fluid pressure alone when seating or unseating from the primary valve seat 178. Accordingly, the faucet 100 can rely on a combination of mechanical inputs and fluid pressure forces to set and maintain piston positions, thereby reducing the amount of required hardware while ensuring stable mode operation during continuous flow.

### 10.7.1 Aerated Mode

In one implementation, the faucet 100 is configured to operate in the aerated mode (e.g., a nominal mode), wherein water is discharged from the aerator nozzle 122, such as for rapidly filling a pot or a sink. In this implementation, in the aerated mode: the primary piston 176 is displaced away from the primary valve seat 178 to establish a fluid path from the cavity 148 to the aerator nozzle 122 and to block passage of fluid from the cavity 148 to the secondary flow selector valve 184; and the secondary piston 186 is seated against the secondary valve seat 188 to block passage of fluid through the secondary flow selector valve 184. In particular, in the aerated mode, fluid enters the fluid inlet, passes through the cavity 148, and flows through an aerated fluid pathway defined within the primary flow selector valve 174 prior to discharging from the aerator nozzle 122.

In one implementation, when the faucet 100 is operating in the soft-flow mode or the flat-fan mode, the faucet 100 is configured to automatically return into the aerated mode as the default outlet configuration upon cessation of flow from the fluid supply. In this implementation, the fluid supply valve (e.g., a shutoff valve or on/off valve) is configured to interrupt passage of fluid from the fluid supply to the fluid inlet in a closed position, such as in response to a user closing the valve. In particular, when the fluid supply valve occupies the closed position: fluid flowing around the primary piston 176 is interrupted; and the spring 146 coupled to the primary piston 176 drives the primary piston 176 into the aerated mode. More specifically, when the fluid supply valve is closed, the spring 146 coupled to the primary piston 176 biases the primary piston 176 toward the aerated mode, re-establishing the flow path to the aerator nozzle 122. For example, when the momentary button 150 is depressed while the primary piston 176 occupies the intermediate mode and the secondary piston 186 occupies the flat-fan mode: fluid flowing around the primary piston 176 is interrupted; and the spring 146 drives the primary piston 176 into the aerated mode. By automatically returning into the aerated mode as a nominal setting, the faucet 100 can consistently start in a predictable, low-splash discharge configuration to minimize unintended spray direction and reduce water waste when initially actuated.

### 10.7.2 Soft-Flow Mode

In one implementation, the faucet 100 is configured to operate in the soft-flow mode, wherein water is discharged from the soft-flow nozzle 124, such as for hand washing or rinsing. In this implementation, in the soft-flow mode: the primary piston 176 is seated against the primary valve seat 178 in the intermediate mode to block passage of fluid from the cavity 148 to the aerator nozzle 122; and the secondary piston 186 is displaced away from the secondary valve seat 188 to establish a fluid path from the primary flow selector valve 174, in the intermediate mode, to the soft-flow nozzle 124. In particular, in the soft-flow mode, fluid enters the fluid inlet, passes through the cavity 148, flows through a soft-flow fluid pathway of the primary flow selector valve 174, and discharges from the soft-flow nozzle 124. Additionally, in the soft-flow mode: fluid flowing around the primary piston 176 compresses the primary piston 176 against the spring 146 to maintain the primary piston 176 in the intermediate mode; and fluid flowing past a first face of the secondary piston 186 maintains the secondary piston 186 in the soft-flow mode (i.e., unseated from the secondary valve seat 188).

In one implementation, the faucet 100 is configured to transition from the aerated mode into the soft-flow mode responsive to user input at the flow selector button 158. In particular, in this implementation, when the flow selector button 158 is depressed while the primary piston 176 occupies the aerated mode: fluid flowing around the primary piston 176 compresses the primary piston 176 against the spring 146 to transition the primary piston 176 into the intermediate mode; and fluid flowing past a first face of the secondary piston 186 unseats the secondary piston 186 from the secondary valve seat 188 to transition the secondary piston 186 into the soft-flow mode. More specifically, when the flow selector button 158 (e.g., a rocker 164 switch) is depressed in a first direction while the primary piston 176 occupies the aerated mode, the flow selector button 158: drives the distal end of the shaft 166 into the primary piston 176 to transition the primary piston 176 from the aerated mode into the intermediate mode; and transitions the secondary piston 186 into the soft-flow mode by unseating the secondary piston 186 from the secondary valve seat 188 to block passage of water to the flat-fan nozzle 126.

In one implementation, the faucet 100 is configured to transition from the soft-flow mode into the aerated mode responsive to user input at the flow selector button 158. In particular, while the momentary button 150 is depressed, while the primary piston 176 occupies the intermediate mode, and the secondary piston 186 occupies the soft-flow mode: fluid flowing around the primary piston 176 is interrupted; and the spring 146 drives the primary piston 176 into the aerated mode. Accordingly, in the soft-flow mode, the coordinated positioning of the primary piston 176 in the intermediate mode and the secondary piston 186 in the unseated position directs fluid exclusively to the soft-flow nozzle 124, and the faucet 100 is configured to revert into the aerated mode to restore the nominal outlet configuration when flow is interrupted or reset by user input.

### 10.7.3 Flat-Fan Mode

In one implementation, the faucet 100 is configured to operate in the flat-fan mode, wherein water is discharged from the flat-fan nozzle 126, such as for removing food from a dish. In this implementation, in the flat-fan mode: the primary piston 176 is seated against the primary valve seat 178 in the intermediate mode to block passage of fluid from the cavity 148 to the aerator nozzle 122; and the secondary piston 186 is seated against the secondary valve seat 188 to establish a fluid path from the primary flow selector valve 174, in the intermediate mode, to the flat-fan nozzle 126. In particular, in the flat-fan mode, fluid enters the fluid inlet, passes through the cavity 148, flows through the primary flow selector valve 174 in the intermediate mode, passes through the secondary flow selector valve 184, and discharges from the flat-fan nozzle 126. Additionally, in the flat-fan mode: fluid flowing around the primary piston 176 compresses the primary piston 176 against the spring 146 to maintain the primary piston 176 in the intermediate mode; and fluid flowing past a second face, opposite the first face, of the secondary piston 186 seats the secondary piston 186 on the secondary valve seat 188 to maintain the secondary piston 186 in the flat-fan mode.

In another implementation, the faucet 100 is configured to transition from the flat-fan mode into the soft-flow mode responsive to user input at the flow selector button 158. In particular, in this implementation, while the flow selector button 158 is depressed in a first direction, while the primary piston 176 occupies the intermediate mode, and the secondary piston 186 occupies the flat-fan mode, the flow selector button 158 transitions the secondary piston 186 into the soft-flow mode.

In another implementation, the faucet 100 is configured to transition from the soft-flow mode into the flat-fan mode responsive to user input at the flow selector button 158. In particular, in this implementation, when the flow selector button 158 is depressed in a second direction, while the primary piston 176 occupies the intermediate mode, and the secondary piston 186 occupies the soft-flow mode, the flow selector button 158 retracts the secondary piston 186 to transition the secondary piston 186 from the soft-flow mode into the flat-fan mode. Accordingly, in the flat-fan mode, the primary piston 176 remains in the intermediate mode to direct flow to the secondary flow selector valve 184, and the seating of the secondary piston 186 on the secondary valve seat 188 channels fluid exclusively to the flat-fan nozzle 126.

### 10.8 Pressure Regulator

In one variation, the faucet 100 can further include a pressure regulator 110 interposed between the fluid inlet and the cavity 148, integrated with the set of flow restrictors, and configured to regulate the fluid supply at the fluid inlet 134 over a range of inlet pressures to a range of internal pressures in the fluid circuit, the range of internal pressures less than and narrower than the range of inlet pressures.

Accordingly, the pressure regulator 110 can: regulate the water pressure within the faucet 100, such that the water pressure remains consistent (e.g., despite variations in the incoming water pressure from the fluid supply); stabilize the flow rate through the set of nozzles 120, thereby enhancing reliability of each function of the faucet 100, such as filling, hand washing, and dish cleaning; and mitigate the impact of pressure fluctuations that can otherwise cause inconsistent water flow, undesirable splashing, or inefficient operation of the nozzles. Therefore, the pressure regulator 110 can: increase longevity and durability of the faucet 100 components by stabilizing internal pressure; reduce the risk of damage or excessive wear resulting from high-pressure surges or inconsistent pressure levels; and enhance user satisfaction by maintaining consistent performance under varying conditions.

### 11. Variation: Faucet with Regulated and Unregulated Fluid Pathways

In one implementation in which the pressure regulator 110, set of nozzles 120, and flow restrictors 142 are integrated into a faucet 100, the faucet 100 can include: a fluid inlet 134 configured to fluidly couple to a fluid supply (e.g., a water main at a kitchen sink), such as via integrated or separated hot and cold valves; an unregulated fluid pathway fluidly coupled to the fluid inlet 134; a regulated fluid pathway fluidly coupled to the fluid inlet 134; a valve between the unregulated and regulated fluid pathways; and a housing 172 defining the fluid inlet 134 and a distal end opposite the fluid inlet 134. In this implementation, the unregulated fluid pathway can include a rigid or flexible fluid supply line extending from the valve to an open-bore outlet at the distal end of the housing 172. (The faucet 100 can also include an aerator across the open-bore outlet.) Similarly, the regulated fluid pathway can include: the pressure regulator 110 coupled to the valve; a rigid or flexible fluid supply line extending from the pressure regulator 110 to a manifold 140 near the distal end of the housing 172; and the set of nozzles 120 fluidly coupled to the manifold 140 and arranged adjacent (e.g., around, circumferentially about) the open-bore outlet at the distal end of the housing 172, as shown in FIG. 3.

For example, the set of nozzles 120 can include a set of (e.g., two, three) flat-fan nozzles 126 arranged about the distal end of the housing 172 with their secondary axes parallel to one another. In this example, the primary axes of the flat-fan nozzles 126 can be angled toward one another such that the sheets of droplets discharged by the flat-fan nozzles 126 meet and cross at some distance (e.g., 6″) from the distal end of the housing 172 to form a high-energy (e.g., high-velocity) spray pattern focused to a long, narrow line at this intersection, which may quickly break and remove food from a dish while limiting consumption of water at the faucet 100 during this rinse process. In particular, in this example, the manifold 140, and the set of valves can be matched to achieve a particular discharge geometry tailored to high-efficiency removal of food waste from dishes, such as including large droplets (e.g., 300 microns in average diameter) moving at high speed and forming a narrow spray (e.g., ¼″ in width) spanning a target length corresponding to a common dish size at a common working distance of the distal end of the faucet 100 to a dish (e.g., a target fan length of 6″ at a distance of 8″ from an average dinner and salad dish 9″ in diameter).

Thus, while the valve occupies a first position that opens the unregulated fluid pathway and closes the regulated fluid pathway, the valve can direct water—at an unregulated pressure-through the open-bore outlet with minimal restrictions, thereby maximizing volume flow rate through the housing 172. A user may therefore set the valve in the first position to quickly fill a pot with water from this faucet. However, while the valve occupies a second position that closes the unregulated fluid pathway and opens the regulated fluid pathway, the valve can direct water into a pressure regulator 110, which regulates the fluid supply down to a target pressure, as described above. The manifold 140 directs this pressure-regulated water to the set of nozzles 120, which discharge droplets from the distal end of the housing 172. As in the foregoing example, a user may therefore set the valve in the second position when rinsing a dish in order to increase rate of food removal while reducing water consumption.

In this implementation, the regulated fluid pathway in the faucet 100 can include: a second manifold 140 arranged near the distal end of the housing 172; a second set of nozzles 120 162 fluidly coupled to the second manifold 140 and arranged near the first set of nozzles 120; a second rigid or flexible fluid supply line fluidly coupled to the second manifold 140; and a second valve interposed between the outlet of the pressure regulator 110 and the fluid supply lines coupled to the first and second sets of nozzles. In this implementation, the second set of nozzles 120 162 can include a set of hollow cone or full cone nozzles, and flow restrictors 142 arranged within the second manifold 140 can be matched to these nozzles and the pressure regulator 110 in order to achieve droplets of moderate size exhibiting lower discharge speeds, greater dwell time, and wider spray angles than the set of flat-fan nozzles 126 for rinsing, which may produce a soft droplet cloud characterized by a low total volume flow rate and a high volumetric ratio of water droplets to air within the sink, thereby enabling a user to efficiently wet and wash her hands.

In the foregoing implementation, the first and second valves can be physically coupled and thus operable in synchronized positions, including: a first position in which the first valve directs water into the unregulated fluid pathway; a second position in which the first valve directs water into the unregulated fluid pathway and the second valve directs water toward the first set of nozzles 120 (e.g., the set of flat-fan nozzles 126); and a third position in which the first valve directs water into the unregulated fluid pathway and the second valve directs water toward the second set of nozzles 120 162 (e.g., the set of hollow or full cone nozzles). Therefore, a user may: set the valves in the first position when filling a pot; set the valves in the second position when rinsing a dish; and set the valves in the third position when washing her hands. Furthermore, in this implementation, the faucet 100 can default to setting the valves in the third position in order to minimize water consumption when the faucet 100 is first actuated (e.g., when a hot or cold valve is opened). (Alternatively, the first and second valves can be integrated into one multi-stage valve defining multiple valve positions and flow paths.)

### 12. Variation: Faucet with Removable Spray Head

In one variation, the faucet 100 can include a removable spray head 170 and a set of flow restrictors (e.g., orifice plates), each flow restrictor corresponding to a particular spray pattern and arranged within the removable spray head 170. In this variation, the faucet 100 can include: a fluid inlet 134 configured to fluidly couple to a fluid supply (e.g., a water main at a kitchen sink), such as via integrated or separated hot and cold valves; the set of flow restrictors; a set of nozzles 120; a valve between each nozzle in the set of nozzles 120; and a housing 172 defining the fluid inlet 134 and a distal end opposite the fluid inlet 134. In this variation, a flexible fluid supply line can extend from the valve to an open-bore outlet at the distal end of the housing 172.

In one example, the faucet 100 includes a housing 172 including a removable spray head 170 including a spray head face. In this example, the faucet 100 includes: a soft-flow nozzle 124 arranged radially about a perimeter of the spray head face; an aerator nozzle 122 arranged on the spray head face inset from the soft-flow nozzle 124; and a flat-fan nozzle 126 arranged on the spray head face inset from the soft-flow nozzle 124 adjacent the aerator nozzle 122. In this example, an orientation of the flat-fan nozzle 126 can be adjusted by the user to customize the flat-fan orientation during rinsing. In particular, the removable spray head 170 can be configured to rotate to achieve a target orientation for the flat-fan distribution during rinsing.

### 12.1 Removable Spray Head Docking

Additionally or alternatively, in the preceding example, the removable spray head 170 can include a set of docking features configured to align the removable spray head 170 with a particular target docking position. In one example, the docking features can include corresponding splines and grooves to align the removable spray head 170 with one of four docking positions. In particular, in this example, an adjustable mount of the removable spray head 170 can include a set of splines arranged radially about the adjustable mount, the set of splines corresponding to a set of grooves arranged radially about the distal end of the housing 172. Each corresponding spline/groove pair can maneuver the removable spray head 170 into one of four docked positions (i.e., 0°, 90°, 180°, 270°).

In another example, the docking features can be configured to rotate the removable spray head 170 to any target position (e.g., enabling 360° rotation), such that the user may orient the removable spray head 170 to any degree of rotation. In another example, the docking features can include corresponding magnetic features located on the adjustable mount and the distal end of the housing 172 to align the removable spray head 170 with a docking position. Therefore, the faucet 100 can be arranged on an adjustable mount, such that the user may—quickly, with a single hand, and without tools—adjust the removable spray head 170 to a particular position based on the user's preferences (e.g., accessibility to buttons based on hand dominance, preferred flat-fan spray angle).

### 13. Variation: Fluid Supply Configurations

In one configuration, the faucet 100 can include a hot valve and a cold valve located in the base of the faucet 100, configured to supply water to the fluid supply valve and control the proportion of hot and cold water delivered to the faucet 100 head. In this configuration, the set of flow restrictors operate when the hot and cold valves are opened sufficiently to maintain a minimum flow rate required by the restrictor/nozzle pairs.

In another configuration, the hot and cold valves can be configured to maintain an output flow rate that meets or exceeds the minimum flow rate required by each flow restrictor and nozzle pair, thereby preventing water trickling and maintaining consistent nozzle performance.

In another configuration, similar to a shower system with separate controls for temperature and flow rate, the faucet 100 includes a temperature control mechanism (e.g., a mixing valve) arranged in the faucet 100 and configured to receive inputs for hot and cold water and adjust the water temperature to a desired output temperature. In this configuration, the temperature control mechanism directs water to two separate fluid pathways (e.g., via a T-split). In particular, the temperature control mechanism directs water to: a manually-controlled flow valve, which regulates the flow rate at the filling nozzle; and a selector valve arranged in the faucet 100 head and configured to control the distribution of water to the flat-fan nozzle 126 and the soft-flow nozzle 124.

Furthermore, in this configuration, while the selector valve is set to a fill position (i.e., corresponding to the aerator nozzle 122) and the manually-controlled flow valve is opened, water flows from the temperature control mechanism to the manually-controlled flow valve, then to the selector valve, and finally to the aerator nozzle 122. Alternatively, while the selector valve is set to a hand washing position (i.e., corresponding to the soft-flow nozzle 124), water flows from the mixing valve through the flow restrictor 142 to the soft-flow nozzle 124, the flow restrictor 142 controlling all flow without the need for an additional manually-controlled flow valve. Similarly, while the selector valve is set to a dish cleaning position (i.e., corresponding to the flat-fan nozzle 126), water flows from the mixing valve through a flow restrictor 142 to the flat-fan nozzle 126, the restrictor controlling all flow, without the need for an additional manually-controlled flow valve.

### 14. Variation: Bathroom Faucet

In one variation, the set of nozzles 120 and flow restrictors 142 are integrated into a bathroom faucet, such as including: a similar unregulated fluid pathway to enable a user to quickly fill a sink when shaving or hand-washing a garment; a first regulated fluid pathway including a first set of flat-fan (or other) nozzles configured to discharge a sheet of higher-speed droplets, such as to enable a user to quickly rinse toothpaste from a toothbrush or soap from her hands; and a second regulated fluid pathway including a second set of nozzles 120 162 (e.g., hollow or full cone nozzles) configured to discharge a cloud or curtain of lower-speed droplets, such as to enable the user to quickly wet her hands when lathering with soap.

In one example, the bathroom faucet includes: a controller; a sensor; and a set of electromechanical valves, including a primary inlet valve, a second valve coupled to the outlet of the primary inlet valve, and a third valve interposed between the second and third fluid pathways. The controller can actuate the electromechanical valves when the sensor detects a user (e.g., a user's hands) nearby. For example, when the controller detects presence of an object proximal the bathroom faucet via the sensor, the controller can: actuate the primary, first, and second valves to pass pressure-regulated water to the second set of valves for a first duration of time (e.g., 5 seconds) to form a soft cloud of slow, large water droplets that enable a user to quickly wet her hands; trigger the primary valve to close for a second duration of time (e.g., three seconds) while the user retrieves a dose of soap (or while a soap dispenser in the bathroom faucet dispenses a dose of soap); trigger the primary valve to open for a third duration of time (e.g., 15 seconds) to form a soft cloud of slow, large water droplets while the user builds a lather in her hands; and then triggers the third valve to shift flow to the second set of nozzles 120 162 for a fourth duration of time (e.g., 8 seconds) to enable the user to rinse soap from her hands; and then trigger the primary valve to close. In this example, if the user selects a button on the bathroom faucet to request high-volume flow (e.g., to fill a water bottle or to fill the sink), the controller can then trigger the primary and second valves to flow water through the unregulated fluid pathway, such as for a preset duration of time (e.g., 10 seconds).

In this foregoing variation, the controller can be further configured to interpret a hand gesture made by a user or motion of a user's hands near the bathroom faucet and can selectively index through the foregoing modes responsive to detected hand gestures and/or motion.

As a person skilled in the art will recognize from the previous detailed description and from the figures and claims, modifications and changes can be made to the embodiments of the invention without departing from the scope of this invention as defined in the following claims.

I claim:

1. A system comprising:
a housing comprising a fluid inlet fluidly coupled to a fluid supply;
a cavity fluidly coupled to and downstream of the fluid inlet;
a momentary shutoff valve:
fluidly coupled to and interposed between the fluid inlet and the cavity; and
configured to:
pass fluid from the fluid inlet into the cavity in an open mode; and
block passage of fluid from the fluid inlet into the cavity in a closed mode;
a first spring configured to bias the momentary shutoff valve in the open mode;
a momentary button:
arranged on the housing; and
configured to transition the momentary shutoff valve between the open mode and the closed mode;
an aerator nozzle arranged on a distal end of the housing;
a soft-flow nozzle arranged on the distal end of the housing adjacent the aerator nozzle;
a flat-fan nozzle arranged on the distal end of the housing adjacent the soft-flow nozzle and the aerator nozzle;
a primary flow selector valve:
fluidly coupled to and downstream of the cavity; and
comprising:
a primary valve seat; and
a primary piston:
unseated from the primary valve seat in an aerated mode to:
pass fluid from the cavity to the aerator nozzle; and
block passage of fluid from the cavity to a secondary flow selector valve; and
seated on the primary valve seat in an intermediate mode to:
pass fluid from the cavity to the secondary flow selector valve; and
block passage of fluid from the cavity to the aerator nozzle;
a second spring configured to bias the primary piston in the aerated mode;
the secondary flow selector valve:
fluidly coupled to and downstream of the primary flow selector valve; and
comprising:
a secondary valve seat; and
a secondary piston:
unseated from the secondary valve seat in a soft-flow mode to:
pass fluid from the primary flow selector valve, in the intermediate mode, to the soft-flow nozzle; and
block passage of fluid from the primary flow selector valve, in the intermediate mode, to the flat-fan nozzle; and
seated on the secondary valve seat in a flat-fan mode to:
pass fluid from the primary flow selector valve, in the intermediate mode, to the flat-fan nozzle; and
block passage of fluid from the primary flow selector valve, in the intermediate mode, to the soft-flow nozzle;
a third spring configured to bias the secondary flow selector valve in the soft-flow mode;
a shaft:
coupled to the secondary piston;
operable in:
a first position locating the secondary piston in the flat-fan mode; and
a second position locating the secondary piston in the soft-flow mode; and
comprising a distal end configured to drive the primary piston from the aerated mode into the intermediate mode during transition of the shaft from the first position into the second position; and
a flow selector button:
arranged on the housing;
coupled to the shaft; and
configured to transition the shaft between the first position and the second position.

2. The system of claim 1, wherein, when the primary piston occupies the intermediate mode:
fluid flowing around the primary piston compresses the primary piston against the second spring to seat the primary piston on the primary valve seat and to maintain the primary piston in the intermediate mode.

3. The system of claim 2:
wherein, when the secondary piston occupies the soft-flow mode:
fluid flowing past a first face of the secondary piston unseats the secondary piston from the secondary valve seat to maintain the secondary piston in the soft-flow mode; and
wherein, when the secondary piston occupies the flat-fan mode:
fluid flowing past a second face, opposite the first face, of the secondary piston seats the secondary piston on the secondary valve seat to maintain the secondary piston in the flat-fan mode.

4. The system of claim 1:
wherein, when the flow selector button is depressed while the primary piston occupies the aerated mode:
the flow selector button:
drives the distal end of the shaft into the primary piston to transition the primary piston from the aerated mode into the intermediate mode; and
transitions the secondary piston into the soft-flow mode; and
fluid flowing around the primary piston compresses the primary piston against the second spring to maintain the primary piston in the intermediate mode; and
wherein, when the momentary button is depressed while the primary piston occupies the intermediate mode and the secondary piston occupies the soft-flow mode:
a fluid supply valve, arranged upstream of the fluid inlet, interrupts fluid flowing around the primary piston; and
the second spring drives the primary piston into the aerated mode.

5. The system of claim 1:
wherein the flow selector button comprises a rocker switch;
wherein, when the rocker switch is depressed in a first direction while the primary piston occupies the aerated mode:
the rocker switch:
drives the distal end of the shaft into the primary piston to transition the primary piston from the aerated mode into the intermediate mode; and
transitions the secondary piston into the soft-flow mode; and
fluid flowing around the primary piston compresses the primary piston against the second spring to maintain the primary piston in the intermediate mode; and
when the rocker switch is depressed in a second direction while the primary piston occupies the intermediate mode and the secondary piston occupies the soft-flow mode:
the rocker switch:
retracts the secondary piston to transition the secondary piston from the soft-flow mode into the flat-fan mode.

6. The system of claim 5:
wherein, when the rocker switch is depressed in the first direction while the primary piston occupies the intermediate mode and the secondary piston occupies the flat-fan mode:
the rocker switch transitions the secondary piston into the soft-flow mode.

7. The system of claim 5:
wherein, when the momentary button is depressed while the primary piston occupies the intermediate mode and the secondary piston occupies the flat-fan mode:
a fluid supply valve, arranged upstream of the fluid inlet, interrupts fluid flowing around the primary piston; and
the second spring drives the primary piston into the aerated mode.

8. The system of claim 5:
further comprising a fluid supply valve:
arranged upstream of the fluid inlet; and
configured to interrupt passage of fluid from the fluid supply to the fluid inlet in a closed position; and
wherein, when the fluid supply valve occupies the closed position:
a fluid supply valve, arranged upstream of the fluid inlet, interrupts fluid flowing around the primary piston; and
the second spring drives the primary piston into the aerated mode.

9. The system of claim 1, further comprising a first flow restrictor:
interposed between the fluid inlet and the aerator nozzle; and
configured to cooperate with the aerator nozzle to discharge water droplets from the aerator nozzle at a first flow rate.

10. The system of claim 1, further comprising:
a first flow restrictor:
interposed between the primary flow selector valve and the aerator nozzle; and
that cooperates with the aerator nozzle to discharge water droplets from the aerator nozzle at a first flow rate;
a second flow restrictor:
arranged upstream of the soft-flow nozzle; and
that cooperates with the soft-flow nozzle to discharge water droplets from the soft-flow nozzle at a second flow rate; and
a third flow restrictor:
interposed between the secondary flow selector valve and the flat-fan nozzle; and
that cooperates with the flat-fan nozzle to discharge water droplets from the flat-fan nozzle at a third flow rate.

11. The system of claim 1:
wherein the aerator nozzle comprises:
a circular aperture configured to discharge water droplets exhibiting an aerated spray pattern; and
an aerator arranged over the circular aperture and configured to mix air with water exiting the aerator nozzle;
wherein the soft-flow nozzle comprises a set of apertures configured to discharge water droplets in a hollow-cylinder spray pattern; and
wherein the flat-fan nozzle comprises a rectilinear aperture configured to discharge water droplets in a flat-fan spray pattern.

12. The system of claim 1:
wherein the housing comprises a spray head comprising a spray head face;
wherein the soft-flow nozzle is arranged radially about a perimeter of the spray head face;
wherein the aerator nozzle is arranged on the spray head face inset from the soft-flow nozzle; and
wherein the flat-fan nozzle is arranged on the spray head face inset from the soft-flow nozzle adjacent the aerator nozzle.

13. A system comprising:
a housing comprising a fluid inlet fluidly coupled to a fluid supply;
a cavity fluidly coupled to and downstream of the fluid inlet;
a momentary shutoff valve:
fluidly coupled to and interposed between the fluid inlet and the cavity; and
configured to:
pass fluid from the fluid inlet into the cavity in an open mode; and
block passage of fluid from the fluid inlet into the cavity in a closed mode;
a momentary button:
arranged on the housing; and
configured to transition the momentary shutoff valve between the open mode and the closed mode;
a first nozzle arranged on a distal end of the housing;
a second nozzle arranged on the distal end of the housing adjacent the first nozzle;
a third nozzle arranged on the distal end of the housing adjacent the second nozzle and the first nozzle;
a primary flow selector valve:
fluidly coupled to and downstream of the cavity; and
comprising:
a primary valve seat; and
a primary piston:
unseated from the primary valve seat in a first mode to:
pass fluid from the cavity to the first nozzle; and
block passage of fluid from the cavity to a secondary flow selector valve; and
seated on the primary valve seat in an intermediate mode to:
pass fluid from the cavity to the secondary flow selector valve; and
block passage of fluid from the cavity to the first nozzle;
the secondary flow selector valve:
fluidly coupled to and downstream of the primary flow selector valve; and
comprising:
a secondary valve seat; and
a secondary piston:
unseated from the secondary valve seat in a second mode to:
pass fluid from the primary flow selector valve, in the intermediate mode, to the second nozzle; and
block passage of fluid from the primary flow selector valve, in the intermediate mode, to the third nozzle; and
seated on the secondary valve seat in a third mode to:
pass fluid from the primary flow selector valve, in the intermediate mode, to the third nozzle; and
block passage of fluid from the primary flow selector valve, in the intermediate mode, to the second nozzle;
a shaft:
coupled to the secondary piston;
operable in:
a first position locating the secondary piston in the third mode; and
a second position locating the secondary piston in the second mode; and
comprising a distal end configured to drive the primary piston from the first mode into the intermediate mode during transition of the shaft from the first position into the second position; and
a flow selector button:
arranged on the housing;
coupled to the shaft; and
configured to transition the shaft between the first position and the second position.

14. The system of claim 13, further comprising:
a first spring configured to bias the momentary shutoff valve in the open mode;
a second spring configured to bias the primary piston in the first mode; and
a third spring configured to bias the secondary flow selector valve in the second mode.

15. A system comprising:
a housing comprising a fluid inlet fluidly coupled to a fluid supply;
a cavity fluidly coupled to and downstream of the fluid inlet;
a momentary shutoff valve:
fluidly coupled to and interposed between the fluid inlet and the cavity; and
configured to:
pass fluid from the fluid inlet into the cavity in an open mode; and
block passage of fluid from the fluid inlet into the cavity in a closed mode;
a momentary button:
arranged on the housing; and
configured to transition the momentary shutoff valve between the open mode and the closed mode;
a first nozzle arranged on a distal end of the housing;
a second nozzle arranged on the distal end of the housing adjacent the first nozzle; and
a primary flow selector valve:
fluidly coupled to and downstream of the cavity; and
comprising:
a primary valve seat; and
a primary piston:
unseated from the primary valve seat in an first mode to:
pass fluid from the cavity to the first nozzle; and
block passage of fluid from the cavity to the second nozzle; and
seated on the primary valve seat in an intermediate mode to:
pass fluid from the cavity to the second nozzle; and
block passage of fluid from the cavity to the first nozzle.

16. The system of claim 15:
wherein a primary piston is:
unseated from the primary valve seat in a first mode to:
pass fluid from the cavity to the first nozzle; and
block passage of fluid from the cavity to a secondary flow selector valve; and
seated on the primary valve seat in an intermediate mode to:
pass fluid from the cavity to the secondary flow selector valve; and
block passage of fluid from the cavity to the first nozzle; and
further comprising:
a third nozzle arranged on the distal end of the housing adjacent the second nozzle and the first nozzle;
the secondary flow selector valve:
fluidly coupled to and downstream of the primary flow selector valve; and
comprising:
a secondary valve seat; and
a secondary piston:
unseated from the secondary valve seat in a second mode to:
pass fluid from the primary flow selector valve, in the intermediate mode, to the second nozzle; and
block passage of fluid from the primary flow selector valve, in the intermediate mode, to the third nozzle; and
seated on the secondary valve seat in a third mode to:
pass fluid from the primary flow selector valve, in the intermediate mode, to the third nozzle; and
block passage of fluid from the primary flow selector valve, in the intermediate mode, to the second nozzle;
a shaft:
coupled to the secondary piston;
operable in:
a first position locating the secondary piston in the third mode; and
a second position locating the secondary piston in the second mode; and
comprising a distal end configured to drive the primary piston from the first mode into the intermediate mode during transition of the shaft from the first position into the second position; and
a flow selector button:
arranged on the housing;
coupled to the shaft; and
configured to transition the shaft between the first position and the second position.

17. The system of claim 16, further comprising:
a first spring configured to bias the momentary shutoff valve in the open mode;
a second spring configured to bias the primary piston in the first mode; and
a third spring configured to bias the secondary flow selector valve in the second mode.
